(19) United States
(12) Patent Application Publication
(10) Pub. No.: US 2013/0250797 A1
(43) Pub. Date: Sep. 26, 2013

(54) COMMUNICATION CONTROL SYSTEM, CONTROL DEVICE, COMMUNICATION CONTROL METHOD, AND COMMUNICATION CONTROL PROGRAM

(71) Applicant: Nobuhiko Itoh, Tokyo (JP)

(72) Inventor: Nobuhiko Itoh, Tokyo (JP)

(21) Appl. No.: 13/990,386

(22) PCT Filed: Dec. 8, 2011
(86) PCT No.: PCT/JP2011/006860

§ 371 Date: May 29, 2013

(30) Foreign Application Priority Data
Dec. 14, 2010 (JP) 2010-278544

(51) Int. Cl. H04L 12/56

(52) U.S. Cl. CPC H04L 45/42
USPC 370/252; 370/400

(57) ABSTRACT

A communication control system includes: a packet transmitting device for transmitting a received packet according to a packet process rule which is a rule defining a process for the packet; and a control device for controlling a transmission route of the packet, by instructing the packet transmitting device to apply the packet process rule. The control device includes a communication method selecting unit for selecting a communication method with the packet transmitting device, according to a communication condition with the packet transmitting device.

### TECHNICAL FIELD

The present invention relates to a communication control system, a control device, a communication control method, and a communication control program for controlling communication while suppressing a transmission delay of a packet sent to another device.

### BACKGROUND ART

A technology called OpenFlow is proposed in recent years (see Non Patent Literatures (NPL) 1 and 2). OpenFlow is a technology that treats communication as an end-to-end flow, and performs path control, failure recovery, load distribution, optimization, and the like on a flow-by-flow basis.

In a network where communication is performed using OpenFlow (hereafter referred to as an OpenFlow network), an OpenFlow switch and an OpenFlow controller are used. The OpenFlow switch functions as a packet transmitting device. The OpenFlow controller functions as a path control device.

The OpenFlow switch includes a secure channel used for communication with the OpenFlow controller, and operates according to a flow table for which an add instruction or a rewrite instruction is appropriately sent from the OpenFlow controller via the secure channel.

FIG. 20 is an explanatory diagram showing the flow table. In the flow table, a combination including: a rule for matching (Header Fields) used for comparison against a packet header; flow statistic information (Counters); and an action (Actions) defining a process for a packet is defined for each flow.

For example, upon receiving a packet, the OpenFlow switch searches the flow table for an entry including a rule for matching that matches header information of the received packet. In the case where the entry matching the received packet is found as a result of the search, the OpenFlow switch updates the flow statistic information (Counters). In this case, the OpenFlow switch also performs a process (e.g. sending the packet from a designated port, flooding, discard) defined in an action field of the entry, on the received packet.

In the case where the entry matching the received packet is not found as a result of searching the flow table, on the other hand, the OpenFlow switch transmits the received packet to the OpenFlow controller via the secure channel. Thus, the OpenFlow switch queries about a process for the packet. For instance, the OpenFlow switch requests the OpenFlow controller to determine a path of the received packet based on a source and a destination of the received packet, receives the determined entry, and updates the flow table. Hence, the OpenFlow switch transmits the packet, by using the entry stored in the flow table as a process rule.

Note that the OpenFlow controller also has a function of collecting the flow statistic information (Counters) that is updated each time a packet is processed. This function is also called a visualization function.

A system in which a switch transmits a packet based on a flow table controlled by a controller is described in Patent Literature (PTL) 1. In the system described in PTL 1, when the switch receives a packet not found in the flow table, the switch transmits the packet to the controller. When the switch receives a packet found in the flow table, the system transmits the packet based on the flow table.

FIG. 21 is an explanatory diagram showing an example of a packet flow in the OpenFlow network. A packet flow in the network described in each of PTL 1, NPL 1, and NPL 2 is described below, with reference to FIG. 21.

In the case where a terminal 310 sends the first data packet to a terminal 320, the data packet is first sent to a packet transmitting device 210 connected to the terminal 310 (step S901). Upon receiving the packet, the packet transmitting device 210 searches a flow table for an entry including a rule for matching (also referred to as a comparison rule or a matching key) that matches header information of the received packet.

However, since the received packet is the first packet, there is no corresponding entry in the flow table. Accordingly, the packet transmitting device 210 buffers the received packet, and then sends a control message indicating that a new flow is detected (hereafter also referred to as an information message about detecting a new flow or a Packet-In message), to a path control device (controller) 100 (step S902).

The Packet-In message includes information necessary for identifying the flow (e.g. a MAC (Media Access Control) address, an IP (Internet Protocol) address, a port number (for both the source and the destination)) and information indicating a destination port of the packet.

It is assumed here that the packet transmitting device 210 buffers the received packet and sends the information necessary for identifying the flow to the path control device (controller) 100, but there is also an instance where the packet transmitting device 210 sends the received packet itself to the path control device (controller) 100.

Upon receiving the Packet-In message, the path control device (controller) 100 creates a comparison rule (matching key) of a new entry from the received message, and determines a timer value applied to the entry. Information created as the comparison rule is, for instance, the information from “InPort” to “TCP/UDP src port” illustrated in FIG. 20.

The path control device (controller) 100 further checks a location of the terminal 320 as the destination based on the received message, and computes a packet transmission route from the terminal 310 to the terminal 320. It is assumed here that, as a result of transmission route computation, the transmission route of transmitting the packet in the order of the packet transmitting device 210→a packet transmitting device 220→a packet transmitting device 230 is computed.

Next, the path control device (controller) 100 creates an entry in which an action defining transmission according to the computed transmission route and the timer value are set for a packet that matches the comparison rule (matching key) of the new entry, for each of the packet transmitting devices 210 to 230. The path control device (controller) 100 notifies each of the packet transmitting devices 210 to 230 of the created entry, using a FlowMod message (step S903). The FlowMod message mentioned here is a message used when the controller requests the switch to register, change, or delete a flow. Upon receiving the FlowMod message, each of the packet transmitting devices 210 to 230 sets the received entry in the flow table.

Having completed the setting of the entry, the packet transmitting device 210 transmits the buffered packet to the packet transmitting device 220, according to the set entry (step S904-1). The packet transmitting devices 220 and 230 on the transmission route through which the packet is to be transmitted have already set the entry, so that the packet is transmitted to the packet transmitting device 220 and then to the packet transmitting device 230, and eventually arrives at the terminal 320 (steps S904-2 and S904-3).

Subsequently, in the case of sending a packet from the terminal 310 to the terminal 320, the packet is transmitted in the order of the packet transmitting device 210→the packet transmitting device 220→the packet transmitting device 230 according to the transmission route (steps S905-1 to S905-4), and arrives at the terminal 320.

A traffic analysis/control system for detecting and analyzing traffic anomaly in a wide area network is described in PTL 2. In the system described in PTL 2, a network includes a packet transmitting device and a network control device, and the network control device indicates a transmission route of a packet flow or the like to the packet transmitting device.

A packet line backup system is described in PTL 3. In the system described in PTL 3, in the case where a fault occurs in a packet line normally used when transmitting a packet to a device in communication and the packet line is disrupted, call setting is performed for the device in communication from a backup line through a line exchange network, according to a predetermined procedure. The packet is then sent to the device in communication via the set backup line.

### CITATION LIST

### Patent Literature

PTL 1: Domestic re-publication of PCT International Application No. WO2008/095010

PTL 2: Japanese Patent Application Laid-Open No. 2008-60865

PTL 3: Japanese Patent Application Laid-Open No. H6-120985

### Non Patent Literature

NPL 1: Nick McKeown, and seven others, “OpenFlow: Enabling Innovation in Campus Networks”, [online], [search on Jul. 6, 2010], Internet <URL:http://www.openflowswitch.org/documents/openflow-wp-latest.pdf>, Mar. 14, 2008 NPL 2: “OpenFlow Switch Specification”, Version 1.0.0. (Wire Protocol 0x01) [search on Jul. 6, 2010], Internet <URL:http://www.openflowswitch.org/documents/openflow-spec-v1.0.0.pdf>, Dec. 31, 2009

### SUMMARY OF INVENTION

### Technical Problem

In the OpenFlow network, the OpenFlow switch receives a data packet. In the case where an entry corresponding to the received packet is not found in the flow table, the OpenFlow switch transmits the received packet to the OpenFlow controller via the secure channel. Thus, the OpenFlow switch queries about an action for the data packet. This query is also referred to as Packet-In.

The OpenFlow controller determines a path of the received packet, based on information indicating a source and a destination of the received packet. The OpenFlow controller sends the determined path information (hereafter also referred to as FlowMod) to all OpenFlow switches on the path, using a secure channel formed according to TCP (Transmission Control Protocol), SSL (Secure Sockets Layer), or the like.

However, if a session between the OpenFlow controller and the OpenFlow switch has poor quality, there is a possibility that a packet including the path information (FlowMod) sent from the OpenFlow controller to the OpenFlow switch does not properly arrive at the OpenFlow switch. Even when the packet arrives at the OpenFlow switch, there is a possibility of a large delay.

A packet flow in such a situation is described below, with reference to FIG. 22. FIG. 22 is an explanatory diagram showing another example of a packet flow in the OpenFlow network. When a data packet sent from the terminal 310 to the terminal 320 arrives at the packet transmitting device 210 (step S201), the packet transmitting device 210 temporarily stores the received packet in a receive buffer. The packet transmitting device 210 then searches the flow table for an entry matching header information of the packet.

In the case where the corresponding entry does not exist in the flow table as a result of the search, the packet transmitting device 210 sends an information message about detecting a new flow (Packet-In message) to the path control device 100 (step S202). Upon receiving the Packet-In message, the path control device 100 computes a transmission route of the data packet. It is assumed here that, as a result of transmission route computation, the transmission route of transmitting the packet in the order of the terminal 310→the packet transmitting device 210→the packet transmitting device 220→the packet transmitting device 230→the terminal 320 is computed. The path control device 100 then sends a FlowMod message to each of the packet transmitting devices 210 to 230 (steps S203-1 to S203-3).

Suppose the FlowMod message to the packet transmitting device 220 (the FlowMod message sent in step S203-2) and the FlowMod message to the packet transmitting device 230 (the FlowMod message sent in step S203-3) arrive at the packet transmitting devices 220 and 230 respectively, but the FlowMod message to the packet transmitting device 210 (the FlowMod message sent in step S203-1) does not arrive at the packet transmitting device 210 due to a packet loss. If the FlowMod message does not arrive at the packet transmitting device 210, the packet transmitting device 210 is unable to transmit the previously stored data packet.

However, the terminal 310 further sends a data packet to the packet transmitting device 210. Each time the packet transmitting device 210 receives a data packet, the packet transmitting device 210 buffers the received packet. When a situation where the packet transmitting device 210 is unable to transmit the data packet continues, a buffer capacity is eventually exceeded, as a result of which a packet loss occurs.

Thus, if a control message sent from the path control device 100 to the packet transmitting device 210 is lost due to a packet loss or the like and does not arrive at the packet transmitting device 210 as scheduled, a loss of a data packet occurs in the packet transmitting device 210. To prevent this, it is desirable to suppress a transmission delay of a packet sent from the OpenFlow controller to the OpenFlow switch.

In the system described in PTL 3, a monitoring packet created at regular time intervals is output to each line in order to detect a fault in the line and, in the case where the fault is detected, communication is switched to a backup line. This requires constant output of the monitoring packet. It is desirable to suppress a transmission delay of a packet without constantly monitoring a line condition as in the system described in PTL 3.

In view of the above, an exemplary object of the present invention is to provide a communication control system, a control device, a communication control method, and a communication control program that can, in a network in which a control device for peforming centralized control of a transmission route sends a process rule to a packet management device for transmitting a packet based on the process rule, suppress a transmission delay of a packet sent from the control device to the packet management device.

### Solution to Problem

A communication control system according to an exemplary aspect of the present invention is a communication control system comprising: a packet transmitting device for transmitting a received packet according to a packet process rule which is a rule defining a process for the packet; and a control device for controlling a transmission route of the packet, by instructing the packet transmitting device to apply the packet process rule, wherein the control device includes communication method selecting means for selecting a communication method with the packet transmitting device, according to a communication condition with the packet transmitting device.

A control device according to an exemplary aspect of the present invention is a control device for controlling a transmission route of a packet by instructing a packet transmitting device to apply a packet process rule which is a rule defining a process for the packet, the packet transmitting device transmitting the received packet according to the packet process rule, the control device comprising communication method selecting means for selecting a communication method with the packet transmitting device, according to a communication condition with the packet transmitting device.

A communication control method according to an exemplary aspect of the present invention is a communication control method wherein a control device for controlling a transmission route of a packet by instructing a packet transmitting device to apply a packet process rule which is a rule defining a process for the packet selects a communication method with the packet transmitting device according to a communication condition with the packet transmitting device, the packet transmitting device transmitting the received packet according to the packet process rule.

A communication control program according to an exemplary aspect of the present invention is a communication control program for use in a computer for controlling a transmission route of a packet by instructing a packet transmitting device to apply a packet process rule which is a rule defining a process for the packet, the packet transmitting device transmitting the received packet according to the packet process rule, the communication control program causing the computer to execute a communication method selecting process of selecting a communication method with the packet transmitting device, according to a communication condition with the packet transmitting device.

### Advantageous Effects of Invention

According to the present invention, in a network in which a control device for performing centralized control of a transmission route sends a process rule to a packet management device for transmitting a packet based on the process rule, a transmission delay of a packet sent from the control device to the packet management device can be suppressed.

### BRIEF DESCRIPTION OF DRAWINGS

FIG. 1 is a block diagram showing an example of a communication control system in Exemplary Embodiment 1 of the present invention.

FIG. 2 is a block diagram showing an example of a packet transmitting device.

FIG. 3 is a block diagram showing an example of a path control device.

FIG. 4 is a flowchart showing an example of a process of establishing a session.

FIG. 5 is an explanatory diagram showing an example of a packet flow.

FIG. 6 is a flowchart showing an example of an operation when receiving an information message about detecting a new flow.

FIG. 7 is a block diagram showing an example of a path control device in Exemplary Embodiment 2 of the present invention.

FIG. 8 is a flowchart showing an example of an operation when receiving an information message about detecting a new flow.

FIG. 9 is a flowchart showing an example of a process of establishing a session.

FIG. 10 is a flowchart showing an example of an operation when receiving a Packet-In message.

FIG. 11 is a flowchart showing an example of a process of selecting a session.

FIG. 12 is a flowchart showing an example of an operation of selecting a session.

FIG. 13 is a flowchart showing an example of an operation when receiving a Packet-In message.

FIG. 14 is a block diagram showing an example of a communication control system in Example 2 of the present invention.

FIG. 15 is an explanatory diagram showing an example of a packet flow.

FIG. 16 is a flowchart showing an example of an operation when receiving a Packet-In message.

FIG. 17 is a flowchart showing an example of a process of selecting a packet sending mode.

FIG. 18 is a block diagram showing an example of a minimum structure of a communication control system according to the present invention.

FIG. 19 is a block diagram showing an example of a minimum structure of a control device according to the present invention.

FIG. 20 is an explanatory diagram showing a flow table.

FIG. 21 is an explanatory diagram showing an example of a packet flow in an OpenFlow network.

FIG. 22 is an explanatory diagram showing another example of a packet flow in the OpenFlow network.

### DESCRIPTION OF EMBODIMENTS

The following describes exemplary embodiments of the present invention with reference to drawings.

### Exemplary Embodiment 1

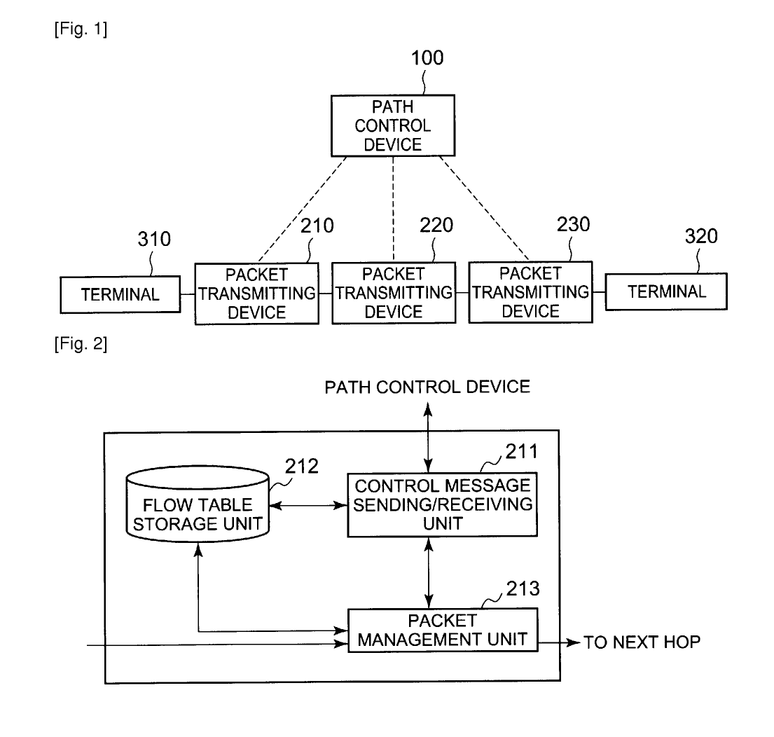

FIG. 1 is a block diagram showing an example of a communication control system in Exemplary Embodiment 1 of the present invention. The communication control system in Exemplary Embodiment 1 includes a path control device 100, packet transmitting devices 210 to 230, and terminals 310 and 320. Note that the number of packet transmitting devices and the number of terminals are not limited to the numbers illustrated in FIG. 1. The number of packet transmitting devices may be one, two, or four or more. The number of terminals may be three or more.

Each of the packet transmitting devices 210 to 230 is a device that, when receiving a packet, transmits the received packet based on a predetermined rule. This rule is also referred to as a packet process rule. For example, the packet transmitting device is realized by a router, a switch, or the like.

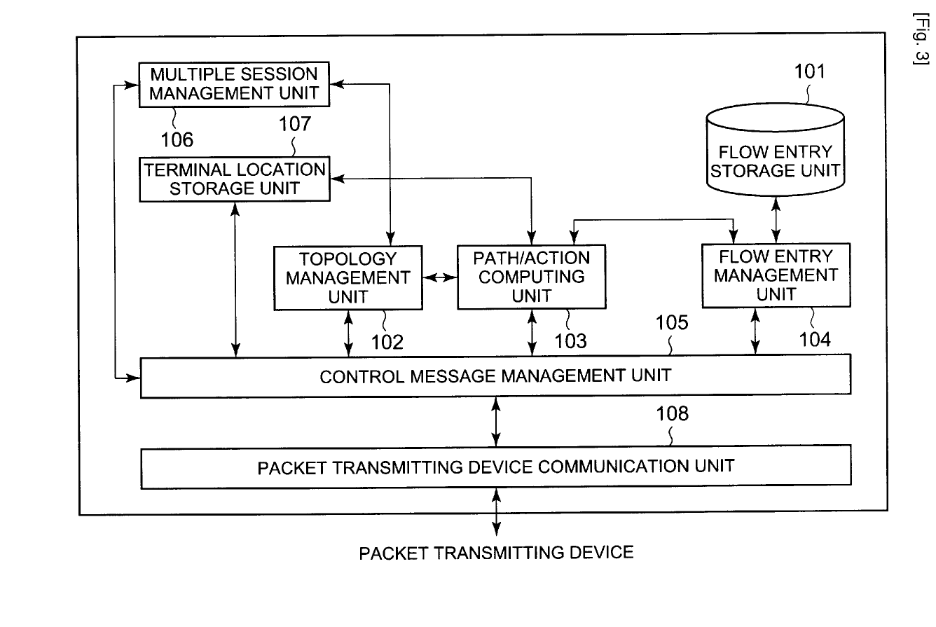

FIG. 2 is a block diagram showing an example of the packet transmitting device 210. Since the packet transmitting devices 220 and 230 have the same structure as the packet transmitting device 210, their description is omitted. The packet transmitting device 210 includes a control message sending/receiving unit 211, a flow table storage unit 212, and a packet management unit 213.

The control message sending/receiving unit 211 has a function of communicating with the path control device 100. That is, the control message sending/receiving unit 211 sends/receives a control message to/from the path control device 100. The control message sending/receiving unit 211 also has a function of managing the number of sessions established with the path control device 100 and a port number for establishing each session.

In detail, the control message sending/receiving unit 211 sends a session establishment request message (SYN message) including a port number for which session establishment is requested, to the path control device 100. Upon receiving a SYN+ACK message from the path control device 100, the control message sending/receiving unit 211 sends an ACK in response to the received message, thereby establishing a session with the path control device 100. Moreover, in the case where the number of sessions is notified from the path control device 100, the control message sending/receiving unit 211 stores the number of sessions in a memory (not shown) or the like.

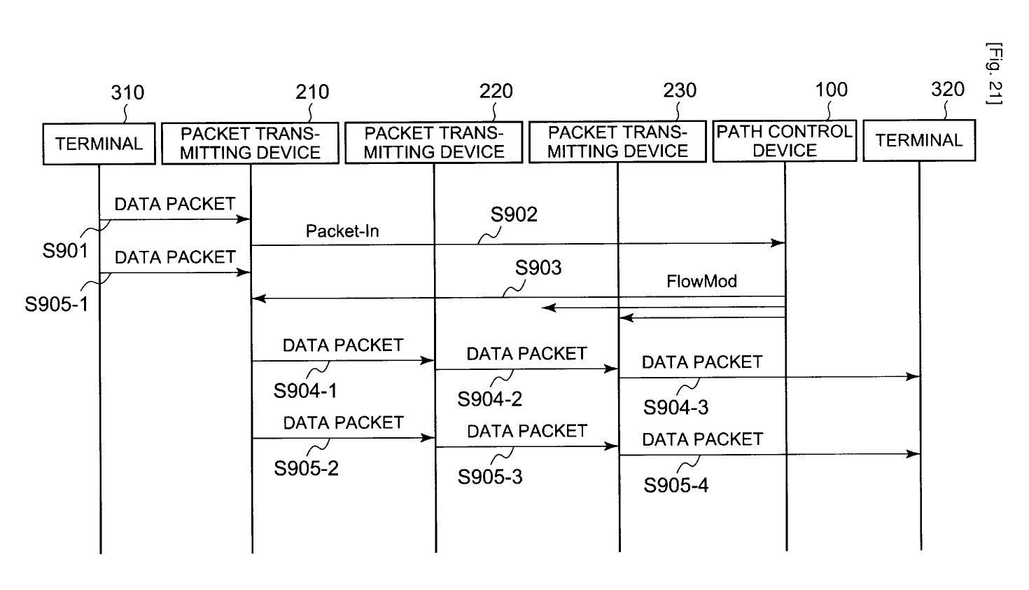

The flow table storage unit 212 stores a flow table. In the flow table, a combination including: a rule for matching (Header Fields) used for comparison against a packet header; flow statistic information (Counters); and an action (Actions) defining a process for a packet is defined for each flow. This combination is hereafter also referred to as a process rule (flow entry). For instance, the information illustrated in FIG. 20 is included in the flow table.

The packet management unit 213 manages a received packet based on an action included in the flow table. In detail, when the packet transmitting device 210 receives a packet, the packet management unit 213 searches the flow table stored in the flow table storage unit 212 for a process rule (flow entry) including a comparison rule (matching key) that matches the received packet. In the case where the flow entry that matches the received packet is found as a result of the search, the packet management unit 213 performs a process (e.g. sending the packet from a designated port, flooding, discard) defined in an action field of the flow entry, on the received packet.

In the case where the entry that matches the received packet is not found in the flow table, the packet management unit 213 sends a control message indicating that a new flow is detected (i.e. an information message about detecting a new flow) to the path control device 100, thereby querying about a process for the packet.

The path control device 100 is a device that performs path control in the network managed by the path control device 100. In detail, the path control device 100 is a device that controls a communication path of a packet by instructing the packet transmitting device to apply a packet process rule. In Exemplary Embodiment 1, the path control device 100 manages the packet transmitting devices 210 to 230. FIG. 3 is a block diagram showing an example of the path control device 100. The path control device 100 includes a flow entry storage unit 101, a topology management unit 102, a path/action computing unit 103, a flow entry management unit 104, a control message management unit 105, a multiple section management unit 106, a terminal location storage unit 107, and a packet transmitting device communication unit 108.

The flow entry storage unit 101 stores a flow entry. In detail, the flow entry storage unit 101 stores a database of a flow entry. For example, the flow entry storage unit 101 is realized by a magnetic disk or the like. As illustrated in FIG. 20, the flow entry storage unit 101 stores a process rule (flow entry) including a comparison rule (rule for matching), an action (including a timer value), and flow statistic information. Note that the flow entry management unit 104 described later stores the flow entry in the flow entry storage unit 101.

The topology management unit 102 creates network topology information based on connection relations of the packet transmitting devices 210 to 230 collected via the packet transmitting device communication unit 108 described later, and stores the created topology information. The topology information mentioned here is information indicating a connection configuration in which a packet transmitting device connects with another device. For example, the topology management unit 102 collects information of a path table held in each of the packet transmitting devices 210 to 230, and creates the network topology information based on the path table. Note, however, that the method of creating the network topology information is not limited to this. The topology management unit 102 may receive network topology information from another path control device 100 and store the received network topology information.

The terminal location storage unit 107 stores terminal location information. For example, the terminal location storage unit 107 stores a database of location information such as an IP address. The terminal location information may be stored in the terminal location storage unit 107 beforehand by an administrator or the like. Alternatively, whenever the path control device 100 receives location information from another path control device, the received location information may be stored in the terminal location storage unit 107. For example, the terminal location storage unit 107 is realized by a magnetic disk or the like.

The path/action computing unit 103 computes an action to be executed by the packet transmitting devices 210 to 230 and a packet transmission route, as a process rule (flow entry). In detail, the path/action computing unit 103 specifies locations of a source terminal and a destination terminal from the location information stored in the terminal location storage unit 107, and computes a transmission route of a packet based on the network topology information managed by the topology management unit 102. The path/action computing unit 103 also determines a process (action) to be executed on the packet by each packet transmitting device on the transmission route. An arbitrary method may be used as the method of determining the action. For example, in the case where the path/action computing unit 103 successfully computes the transmission route, the path/action computing unit 103 may determine that an action of transmitting the packet is to be executed. For a packet of a predetermined type, on the other hand, the path/action computing unit 103 may determine that a predetermined action such as discarding the packet, transmitting the packet to a predetermined device, or the like is to be executed.

The flow entry management unit 104 creates a comparison rule (matching key), based on information received from the packet transmitting device. The flow entry management unit 104 also stores the flow entry computed by the path/action computing unit 103, in the flow entry storage unit 101. Moreover, in response to a request to add or update a process rule (flow entry) from any of the packet transmitting devices 210 to 230, the flow entry management unit 104 instructs the packet transmitting device to set the process rule (flow entry) in the flow table storage unit 212.

The control message management unit 105 analyzes a control message received from any of the packet transmitting devices 210 to 230, and passes the control message to a corresponding unit in the path control device 100. For example, in the case of receiving an information message about detecting a new flow from any of the packet transmitting devices 210 to 230, the control message management unit 105 requests the flow entry management unit 104 to check whether or not a process rule (flow entry) corresponding to the new flow is registered in the flow entry storage unit 101. In the case where the corresponding flow entry is not registered in the flow entry storage unit 101, the control message management unit 105 requests the path/action computing unit 103 to create a new process rule (flow entry).

The multiple session management unit 106 establishes a plurality of sessions with one packet transmitting device. In detail, the multiple session management unit 106 has a function of determining the number of sessions established with the packet transmitting device 210 and a port number used for establishing each session, upon session establishment between the path control device 100 and the packet transmitting device 210.

An arbitrary method may be used as the method of determining the port number. As an example, the multiple session management unit 106 may randomly determine a port number other than well-known port numbers. The method of determining the port number is not limited to such a random determination method. As another example, the multiple session management unit 106 may select a smallest port number from unused port numbers other than the well-known port numbers. Besides, the multiple session management unit 106 may determine, for instance, the number of sessions set beforehand in a configuration file or the like, as the number of sessions established, though the method of determining the number of sessions established is not limited to such a method.

The packet transmitting device communication unit 108 has a function by which the path control device 100 communicates with the packet transmitting devices 210 to 230. That is, the packet transmitting device communication unit 108 sends/receives a packet to/from each of the packet transmitting devices 210 to 230. The packet transmitting device communication unit 108 also selects a communication method between the path control device 100 and the packet transmitting device, according to a communication condition with the packet transmitting device. In detail, the packet transmitting device communication unit 108 selects a session used for communication, from the plurality of sessions established by the multiple session management unit 106.

For example, the packet transmitting device communication unit 108 may select a session of highest communication quality from the plurality of sessions, as the session used for communication. As an example of a basis for determining communication quality, a session having a smaller number of retransmitting operations may be determined as a session of higher communication quality. In the case where an anomaly such as network congestion or a communication failure occurs in communication, the number of retransmitting operations tends to increase. This being so, by selecting a session having a smaller number of retransmitting operations, a transmission delay of a message sent from the path control device 100 to the packet transmitting device can be suppressed. Alternatively, the packet transmitting device communication unit 108 may determine a session having a smaller value of a retransmission timer described later to have a better communication condition, and select the better session as the session used for communication with the packet transmitting device.

The topology management unit 102, the path/action computing unit 103, the flow entry management unit 104, the control message management unit 105, the multiple session management unit 106, and the packet transmitting device communication unit 108 are realized by a CPU of a computer operating according to a program (communication control program). For example, the program may be stored in a storage unit (not shown) in the path control device 100, with the CPU reading the program and, according to the program, operating as the topology management unit 102, the path/action computing unit 103, the flow entry management unit 104, the control message management unit 105, the multiple session management unit 106, and the packet transmitting device communication unit 108.

Alternatively, the topology management unit 102, the path/action computing unit 103, the flow entry management unit 104, the control message management unit 105, the multiple session management unit 106, and the packet transmitting device communication unit 108 may be each realized by dedicated hardware.

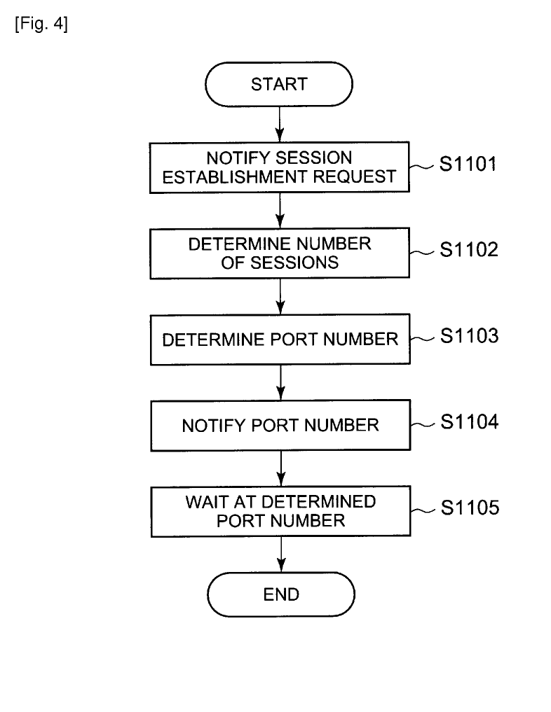

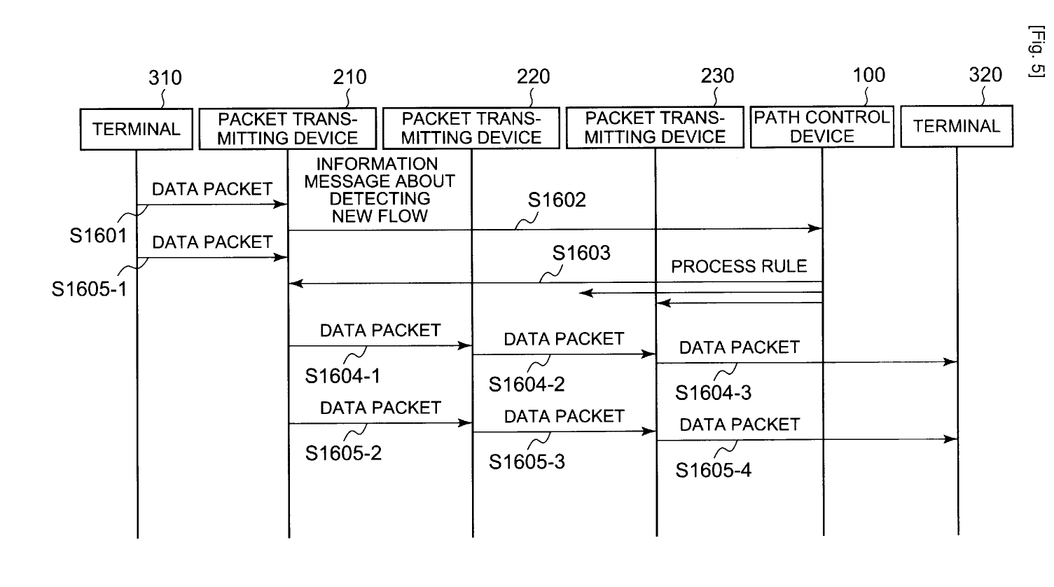

The following describes an operation of the communication control system in Exemplary Embodiment 1. FIG. 4 is a flowchart showing an example of a process of establishing a session between the path control device and the packet transmitting device.

A procedure when the packet transmitting device 210 joins the network managed by the path control device 100 is described first. Though the following describes the case where session establishment is initiated by the packet transmitting device, session establishment may instead be initiated by the path control device. First, the packet transmitting device 210 establishes a session for notifying the path control device 100 of information of the packet transmitting device 210, upon joining the network managed by the path control device 100.

The control message sending/receiving unit 211 in each of the packet transmitting devices 210 to 230 sends a session establishment request message (SYN message) to the path control device 100. The SYN message includes information such as a port number of a server to be connected. Suppose, for example, “6633” is designated in the SYN message as the port number of the server. When the path control device 100 receives this SYN message, the multiple session management unit 106 sends a SYN+ACK message to the packet transmitting device 210, according to a TCP session establishment procedure.

When the packet transmitting device 210 receives the SYN+ACK message, the control message sending/receiving unit 211 sends an ACK in response to the SYN+ACK message, to the path control device 100. As a result, one TCP session is established between the path control device 100 and the packet transmitting device 210.

When the path control device 100 receives the first SYN message from the packet transmitting device 210 at the same time as this TCP session establishment, the control message management unit 105 notifies the multiple session management unit 106 that a session establishment request is made from the packet transmitting device 210 (step S1101). The multiple session management unit 106 then determines the number of sessions established between the path control device 100 and the packet transmitting device 210 (step S1102). Suppose the number of sessions established between the path control device 100 and the packet transmitting device 210 is determined as two. In this case, the multiple session management unit 106 determines a port number necessary for establishing the second session (step S1103).

The multiple session management unit 106 determines the port number other than the well-known port numbers. It is assumed here that the multiple session management unit 106 randomly determines the port number, and thus selects “1024” as the port number. Note that the method of determining the port number is not limited to such a random determination method. The multiple session management unit 106 may select, for example, a smallest port number from unused port numbers other than the well-known port numbers.

The packet transmitting device communication unit 108 notifies the packet transmitting device 210 of the port number determined by the multiple session management unit 106 (step S1104). This notification may be made by including the port number in an arbitrary message sent from the path control device 100 to the packet transmitting device 210, or in a dedicated message separately created for notifying the port number.

The path control device 100 then waits for a session establishment request from the packet transmitting device 210 at the port number “1024” (step S1105). The control message sending/receiving unit 211 in the packet transmitting device 210 sends a SYN message including the port number “1024”, to the path control device 100. A subsequent operation until a session is established is the same as the above-mentioned operation.

In the case where the number of sessions established is determined as N in step S1102, the multiple session management unit 106 selects N port numbers in step S1103, and the packet transmitting device communication unit 108 performs steps S1104 and S1105. For example, the network shown in FIG. 1 is built as a result of such session establishment between the path control device 100 and the packet transmitting devices 210 to 230.

The following describes an operation when a data packet arrives at the built network. FIG. 5 is an explanatory diagram showing an example of a packet flow.

In the case where the terminal 310 sends a data packet to the terminal 320, the data packet arrives at the packet transmitting device 210 (step S1601). The packet management unit 213 searches the flow table for an entry including a comparison rule (matching key) that matches header information of the received packet. However, since the received packet is the first packet, there is no corresponding entry in the flow table. Accordingly, the packet management unit 213 buffers the received packet, and then sends an information message about detecting a new flow to the path control device 100 (step S1602).

The information message about detecting a new flow includes information necessary for identifying the flow (e.g. a MAC address, an IP address, a port number (for both the source and the destination)) and information indicating a destination port of the packet.

It is assumed here that the packet transmitting device 210 buffers the received packet and sends the information necessary for identifying the flow to the path control device 100, but the packet transmitting device 210 may send the received packet itself to the path control device 100.

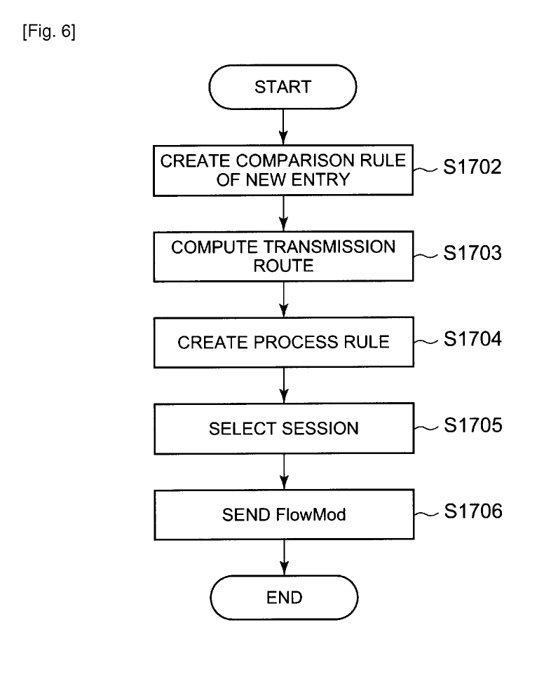

An operation when the path control device 100 receives the information message about detecting a new flow is described below. FIG. 6 is a flowchart showing an example of the operation when the path control device 100 receives the information message about detecting a new flow.

When the path control device (controller) 100 receives the information message about detecting a new flow, the path/action computing unit 103 creates a comparison rule (matching key) of a new entry based on the received information, and determines a timer value applied to the entry (step S1702). Information created as the comparison rule is, for instance, the information from “InPort” to “TCP/UDP src port” illustrated in FIG. 20. The path/action computing unit 103 further checks a location of the terminal 320 as the destination based on the received information, and computes a packet transmission route from the terminal 310 to the terminal 320 (step S1703). It is assumed here that, as a result of transmission route computation, the transmission route of transmitting the packet in the order of the packet transmitting device 210→the packet transmitting device 220→the packet transmitting device 230 is computed.

Next, the path/action computing unit 103 creates an entry (process rule) in which an action defining transmission according to the computed transmission route and the timer value are set for a packet that matches the comparison rule (matching key) of the new entry, for each of the packet transmitting devices 210 to 230 (step S1704). After the entry is created, the packet transmitting device communication unit 108 selects a session for sending the entry (process rule) (step S1705), and sends the process rule (FlowMod) using the selected session (step S1706).

Thus, the path control device 100 sends the process rule to each of the packet transmitting devices 210 to 230 according to the procedure illustrated in FIG. 6 (step S1603 in FIG. 5).

When each of the packet transmitting devices 210 to 230 receives the process rule from the path control device 100, the control message sending/receiving unit 211 sets the received entry in the flow table. The packet management unit 213 transmits the buffered packet to the packet transmitting device 220, according to the set entry (step S1604-1). The packet transmitting devices 220 and 230 on the transmission route through which the packet is to be transmitted have already set the entry, so that the packet is transmitted to the packet transmitting device 220 and then to the packet transmitting device 230, and eventually arrives at the terminal 320 (steps S1604-2 and S1604-3).

Subsequently, in the case of sending a packet from the terminal 310 to the terminal 320, the packet is transmitted in the order of the packet transmitting device 210→the packet transmitting device 220→the packet transmitting device 230 according to the transmission route (steps S1605-1 to S1605-4), and arrives at the terminal 320.

As described above, according to Exemplary Embodiment 1, the packet transmitting device communication unit 108 in the path control device 100 selects a communication method with the packet transmitting device, according to a communication condition with the packet transmitting device. In detail, the multiple session management unit 106 establishes a plurality of sessions with the packet transmitting device, and the packet transmitting device communication unit 108 selects a session used for communication with the packet transmitting device from the plurality of sessions, according to the communication condition with the packet transmitting device with which the plurality of sessions are established (for example, selects a session of a better communication condition). According to this structure, a transmission delay of a packet sent from the path control device 100 to the packet management device can be suppressed.

### Exemplary Embodiment 2

The following describes a communication control system in Exemplary Embodiment 2 of the present invention. Exemplary Embodiment 1 describes the case where a plurality of sessions are established between the path control device 100 and the packet transmitting devices 210 to 230 to prepare for an anomalous condition. Exemplary Embodiment 2 differs from Exemplary Embodiment 1 in that the number of sessions established is one and a sending mode is selected according to a packet to be sent. In more detail, whether to send in a normal mode or an urgent mode is selected according to information included in the packet to be sent.

The urgent mode mentioned here is a mode of sending the packet with higher priority than in normal time. Examples of a situation to which the urgent mode applies include a situation where a TCP session is in a retransmission phase and the packet cannot be sent immediately, a situation where the packet to be sent is an important packet, and so on.

As illustrated in FIG. 1, the communication control system in Exemplary Embodiment 2 includes the path control device 100, the packet transmitting devices 210 to 230, and the terminals 310 and 320, as in Exemplary Embodiment 1. The path control device 100 is a device that performs path control of the network managed by the path control device 100, and manages the packet transmitting devices 210 to 230, as in Exemplary Embodiment 1.

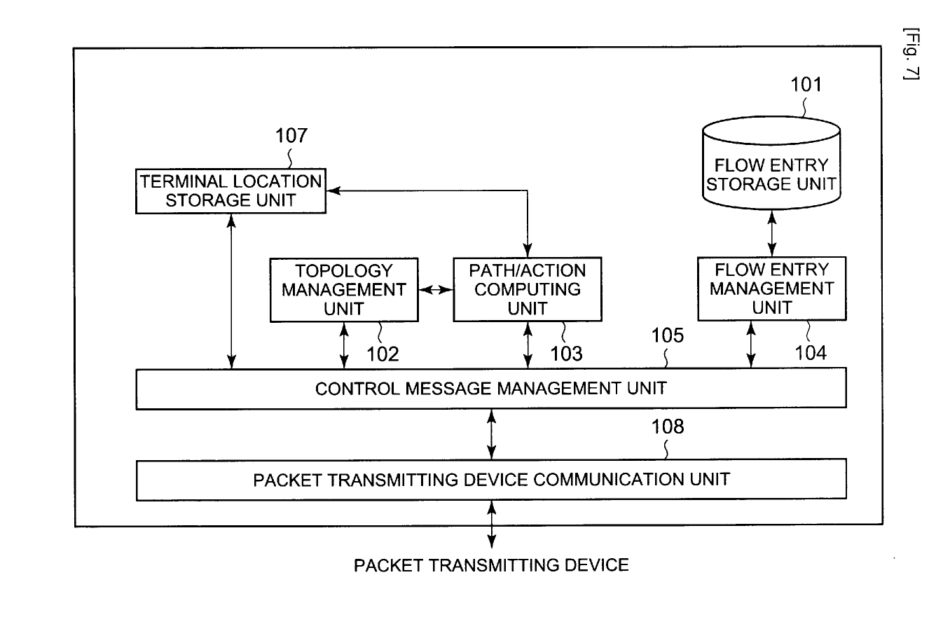

FIG. 7 is a block diagram showing an example of the path control device 100 in Exemplary Embodiment 2 of the present invention. The path control device 100 in Exemplary Embodiment 2 includes the flow entry storage unit 101, the topology management unit 102, the path/action computing unit 103, the flow entry management unit 104, the control message management unit 105, the terminal location storage unit 107, and the packet transmitting device communication unit 108.

In Exemplary Embodiment 1, the multiple session management unit 106 illustrated in FIG. 3 has a function of establishing a plurality of sessions, and the packet transmitting device communication unit 108 has a function of selecting a session used for communication from the plurality of sessions. In addition, in Exemplary Embodiment 1, the packet transmitting device communication unit 108 has a function of managing the number of sessions established and a port number for establishing each session with the control message sending/receiving unit 211 in the packet transmitting device illustrated in FIG. 2. The communication control system in Exemplary Embodiment 2, on the other hand, does not include these functions. The communication control system in Exemplary Embodiment 2 differs from the communication control system in Exemplary Embodiment 1, in that the packet transmitting device communication unit 108 illustrated in FIG. 7 has a function of determining whether or not a packet to be sent is important and, if the packet is important, sending the packet with priority in the urgent mode. This is described in detail below.

The flow entry storage unit 101 stores a flow entry. In detail, the flow entry storage unit 101 stores a database of a flow entry. For example, the flow entry storage unit 101 is realized by a magnetic disk or the like. As illustrated in FIG. 20, the flow entry storage unit 101 stores a process rule (flow entry) including a comparison rule (rule for matching), an action (including a timer value), and flow statistic information. Note that the flow entry management unit 104 stores the flow entry in the flow entry storage unit 101.

The topology management unit 102 creates network topology information based on connection relations of the packet transmitting devices 210 to 230 collected via the packet transmitting device communication unit 108 described later, and stores the created topology information. The method of creating and storing the topology information is the same as that in Exemplary Embodiment 1. The terminal location storage unit 107 stores terminal location information. The information stored in the terminal location storage unit 107 is the same as that in Exemplary Embodiment 1. For example, the terminal location storage unit 107 is realized by a magnetic disk or the like.

The path/action computing unit 103 computes an action to be executed by the packet transmitting devices 210 to 230 and a packet transmission route, as a process rule (flow entry). In detail, the path/action computing unit 103 specifies locations of a source terminal and a destination terminal from the location information stored in the terminal location storage unit 107, and computes a transmission route of a packet based on the network topology information managed by the topology management unit 102. The path/action computing unit 103 also determines a process (action) to be executed on the packet by each packet transmitting device on the transmission route. The method of determining the action and the method of computing the transmission route of the packet are the same as those in Exemplary Embodiment 1.

The flow entry management unit 104 creates a comparison rule (matching key), based on information received from the packet transmitting device. The flow entry management unit 104 also stores the flow entry computed by the path/action computing unit 103, in the flow entry storage unit 101. Moreover, in response to a request to add or update a process rule (flow entry) from any of the packet transmitting devices 210 to 230, the flow entry management unit 104 instructs the packet transmitting device to set the process rule (flow entry) in the flow table storage unit 212.

The control message management unit 105 analyzes a control message received from any of the packet transmitting devices 210 to 230, and passes the control message to a corresponding unit in the path control device 100. For example, in the case of receiving an information message about detecting a new flow from any of the packet transmitting devices 210 to 230, the control message management unit 105 requests the flow entry management unit 104 to check whether or not a process rule (flow entry) corresponding to the new flow is registered in the flow entry storage unit 101. In the case where the corresponding flow entry is not registered in the flow entry storage unit 101, the control message management unit 105 requests the path/action computing unit 103 to create a new process rule (flow entry).

The packet transmitting device communication unit 108 has a function by which the path control device 100 communicates with the packet transmitting devices 210 to 230. That is, the packet transmitting device communication unit 108 sends/receives a packet to/from each of the packet transmitting devices 210 to 230. The packet transmitting device communication unit 108 also selects a sending mode according to a packet communication condition.

In more detail, in a situation where a packet to be sent needs to be sent with higher priority than in normal time (i.e. the packet has higher importance), the packet transmitting device communication unit 108 determines to send the packet in the urgent mode, and sends the packet with priority. Examples of the situation where the packet needs to be sent with priority include a situation where the TCP session is in the retransmission phase and the packet cannot be sent immediately, a situation where the packet to be sent is an important packet, and so on. The packet transmitting device communication unit 108 determines whether or not the packet needs to be sent with priority, based on these situations specified beforehand. Here, the packet transmitting device communication unit 108 may reference to a value of a retransmission timer, to determine whether or not the TCP session is in the retransmission phase. Moreover, the packet transmitting device communication unit 108 may reference to, among the information included in the packet, information (e.g. a URG (Urgent) flag) indicating the importance of the packet, to determine whether or not the packet is an important packet. When the value of the retransmission timer defined in TCP is smaller, the packet transmitting device communication unit 108 determines that the communication condition is better, and selects the better session as a session used for communication with the packet transmitting device.

The topology management unit 102, the path/action computing unit 103, the flow entry management unit 104, the control message management unit 105, and the packet transmitting device communication unit 108 are realized by a CPU of a computer operating according to a program (communication control program). Alternatively, the topology management unit 102, the path/action computing unit 103, the flow entry management unit 104, the control message management unit 105, and the packet transmitting device communication unit 108 may be each realized by dedicated hardware.

Each of the packet transmitting devices 210 to 230 is a device that, when receiving a packet, transmits the received packet based on a predetermined rule, as in Exemplary Embodiment 1. The packet transmitting devices 210 to 230 in Exemplary Embodiment 2 have the same structure as the structure illustrated in FIG. 2. That is, the packet transmitting device 210 in Exemplary Embodiment 2 includes the control message sending/receiving unit 211, the flow table storage unit 212, and the packet management unit 213, as in Exemplary Embodiment 1.

The control message sending/receiving unit 211 has a function of communicating with the path control device 100.

The flow table storage unit 212 stores a flow table. In the flow table, a combination including: a rule for matching (Header Fields) used for comparison against a packet header; flow statistic information (Counters); and an action (Actions) defining a process for a packet is defined for each flow (see FIG. 20), as in Exemplary Embodiment 1.

The packet management unit 213 searches the flow table stored in the flow table storage unit 212 for a process rule (flow entry) including a comparison rule (matching key) that matches a received packet, and performs a process (e.g. transmitting to a designated port, flooding, discard) defined in an action field of the process rule (flow entry).

The following describes an operation of the communication control system in Exemplary Embodiment 2, with reference to FIG. 5.

In the case where the terminal 310 sends a data packet to the terminal 320, the data packet arrives at the packet transmitting device 210 (step S1601). The packet management unit 213 searches the flow table for an entry including a comparison rule (matching key) that matches header information of the received packet. However, since the received packet is the first packet, there is no corresponding entry in the flow table. Accordingly, the packet management unit 213 buffers the received packet, and then sends an information message about detecting a new flow to the path control device 100 (step S1602).

The information message about detecting a new flow includes information necessary for identifying the flow (e.g. a MAC address, an IP address, a port number (for both the source and the destination)) and information indicating a destination port of the packet.

It is assumed here that the packet transmitting device 210 buffers the received packet and sends the information necessary for identifying the flow to the path control device 100, but the packet transmitting device 210 may send the received packet itself to the path control device 100.

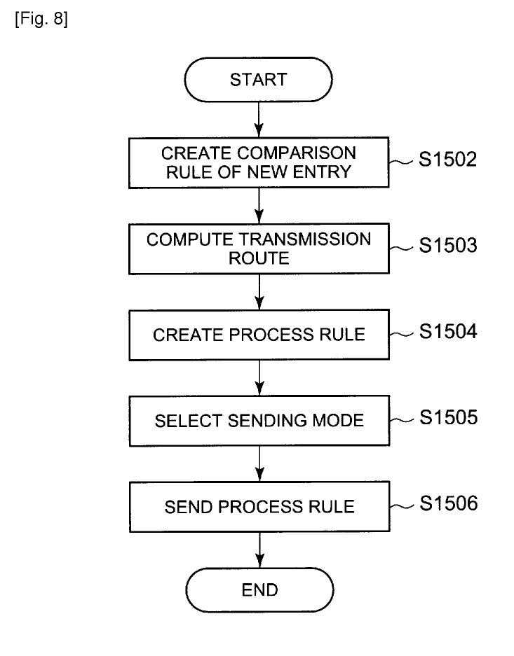

An operation when the path control device 100 receives the information message about detecting a new flow is described below. FIG. 8 is a flowchart showing an example of the operation when the path control device 100 receives the information message about detecting a new flow.

When the path control device (controller) 100 receives the information message about detecting a new flow, the path/action computing unit 103 creates a comparison rule (matching key) of a new entry based on the received information, and determines a timer value applied to the entry (step S1502). Information created as the comparison rule is, for instance, the information from “InPort” to “TCP/UDP src port” illustrated in FIG. 20. The path/action computing unit 103 further checks a location of the terminal 320 as the destination based on the received information, and computes a packet transmission route from the terminal 310 to the terminal 320 (step S1503). It is assumed here that, as a result of transmission route computation, the transmission route of transmitting the packet in the order of the packet transmitting device 210→the packet transmitting device 220→the packet transmitting device 230 is computed.

Next, the path/action computing unit 103 creates an entry (process rule) in which an action defining transmission according to the computed transmission route and the timer value are set for a packet that matches the comparison rule (matching key) of the new entry, for each of the packet transmitting devices 210 to 230 (step S1504).

Following this, the packet transmitting device communication unit 108 in the path control device 100 selects a sending mode, according to a packet communication condition (step S1505). In detail, the packet transmitting device communication unit 108 selects whether to send in the normal mode or the urgent mode, according to a communication condition of a packet to be sent. Examples of a situation to which the urgent mode applies include a situation where the TCP session is in the retransmission phase and the packet cannot be sent immediately, a situation where the packet to be sent is an important packet, and so on.

The packet transmitting device communication unit 108 in the path control device 100 sends the process rule in the sending mode selected in step S1505 (step S1506).

When each of the packet transmitting devices 210 to 230 receives the process rule from the path control device (controller) 100, the control message sending/receiving unit 211 sets the received entry in the flow table. The packet management unit 213 transmits the buffered packet to the packet transmitting device 220, according to the set entry (step S1604-1 in FIG. 5). The packet transmitting devices 220 and 230 on the transmission route through which the packet is to be transmitted have already set the entry, so that the packet is transmitted to the packet transmitting device 220 and then to the packet transmitting device 230, and eventually arrives at the terminal 320 (steps S1604-2 and S1604-3).

Subsequently, in the case of sending a packet from the terminal 310 to the terminal 320, the packet is transmitted in the order of the packet transmitting device 210→the packet transmitting device 220→the packet transmitting device 230 according to the transmission route (steps S1605-1 to S1605-4), and arrives at the terminal 320.

As described above, according to Exemplary Embodiment 2, the packet transmitting device communication unit 108 in the path control device 100 selects a communication method with the packet transmitting device, according to a communication condition with the packet transmitting device. In detail, the packet transmitting device communication unit 108 selects the communication method of sending in the urgent mode, according to the communication condition with the packet transmitting device (for example, a situation where the TCP session is in the retransmission phase or a situation where the packet to be sent is an important packet). According to this structure, too, a transmission delay of a packet sent from the path control device 100 to the packet management device can be suppressed.

### Example 1

The following describes the present invention by way of specific examples. However, the scope of the present invention is not limited to the following. Example 1 corresponds to the communication control system in Exemplary Embodiment 1 of the present invention. A communication control system in Example 1 is described below, with reference to FIGS. 1, 2, and 3.

A communication control system intended for the OpenFlow network is described in Example 1. The path control device (controller) corresponds to a device that includes, in the OpenFlow controller, a function of managing a plurality of sessions and selecting a desired session from the plurality of sessions. Meanwhile, the packet transmitting device corresponds to a device that includes, in the OpenFlow switch, a function of holding the number of sessions established with the path control device (controller) and a port number for establishing each session.

As illustrated in FIG. 1, the communication control system in Example 1 includes the two terminals 310 and 320, the three packet transmitting devices 210 to 230 between the terminals 310 and 320, and the path control device 100 for controlling the network.

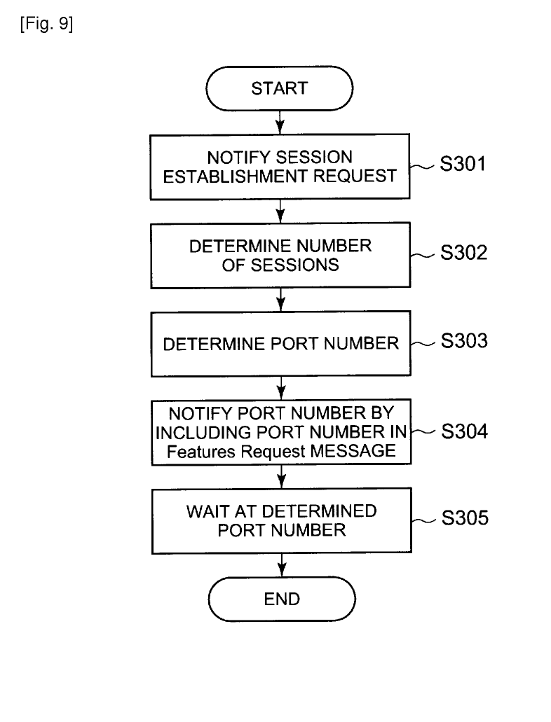

FIG. 9 is a flowchart showing an example of a process of establishing a session between the path control device and the packet transmitting device. An operation of the communication control system in Example 1 is described below, with reference to FIG. 9.

A procedure when the packet transmitting device 210 joins the OpenFlow network managed by the path control device (controller) 100 is described first. Though the following describes the case where session establishment in the OpenFlow network is initiated by the packet transmitting devices 210 to 230, session establishment may instead be initiated by the path control device (controller) 100. First, the packet transmitting device 210 establishes a session for notifying the path control device 100 of information of the packet transmitting device 210, upon joining the network managed by the path control device (controller) 100. It is assumed here that the session is established in a secure channel (TCP or SSL).

The control message sending/receiving unit 211 in each of the packet transmitting devices 210 to 230 sends a session establishment request message (SYN message) to the path control device (controller) 100. The SYN message includes information such as a port number of a server to be connected. Suppose, for example, “6633” is designated in the SYN message as the port number of the server. When the path control device 100 receives this SYN message, the multiple session management unit 106 sends a SYN+ACK message to the packet transmitting device 210, according to a TCP session establishment procedure (mechanism).

When the packet transmitting device 210 receives the SYN+ACK message, the control message sending/receiving unit 211 sends an ACK in response to the SYN+ACK message, to the path control device 100. As a result, one TCP session is established between the path control device 100 and the packet transmitting device 210.

When the path control device 100 receives the first SYN message from the packet transmitting device 210 at the same time as this TCP session establishment, the control message management unit 105 notifies the multiple session management unit 106 that a session establishment request is made from the packet transmitting device 210 (step S301). The multiple session management unit 106 then determines the number of sessions (the number of connections) established between the path control device 100 and the packet transmitting device 210 (step S302). Suppose the number of sessions established between the path control device 100 and the packet transmitting device 210 is determined as two. In this case, the multiple session management unit 106 determines a port number necessary for establishing the second session (step S303).

The multiple session management unit 106 determines the port number other than the well-known port numbers. It is assumed here that the multiple session management unit 106 randomly determines the port number, and thus selects “1024” as the port number. Note that the method of determining the port number is not limited to such a random determination method. The multiple session management unit 106 may select, for example, a smallest port number from unused port numbers other than the well-known port numbers.

The packet transmitting device communication unit 108 notifies the packet transmitting device 210 of the port number determined by the multiple session management unit 106, by including the port number in a Features Request message (step S304). Note that the message used when notifying the port number is not limited to the Features Request message. The notification may be made by including the port number in an arbitrary message sent from the path control device 100 to the packet transmitting device 210, or in a dedicated message separately created for notifying the port number.

The path control device 100 then waits for a session establishment request from the packet transmitting device 210 at the port number “1024” (step S305). The control message sending/receiving unit 211 in the packet transmitting device 210 sends a Features Reply in response to the Features Request to the path control device (controller) 100, and then sends a SYN message including the port number “1024” to the path control device (controller) 100. A subsequent operation until a session is established is the same as the above-mentioned operation.

In the case where the number of sessions established is determined as N in step S302, the multiple session management unit 106 selects N port numbers in step S303, and the packet transmitting device communication unit 108 performs steps S304 and S305. The OpenFlow network is built as a result of such session establishment between the path control device 100 and the packet transmitting devices 210 to 230.

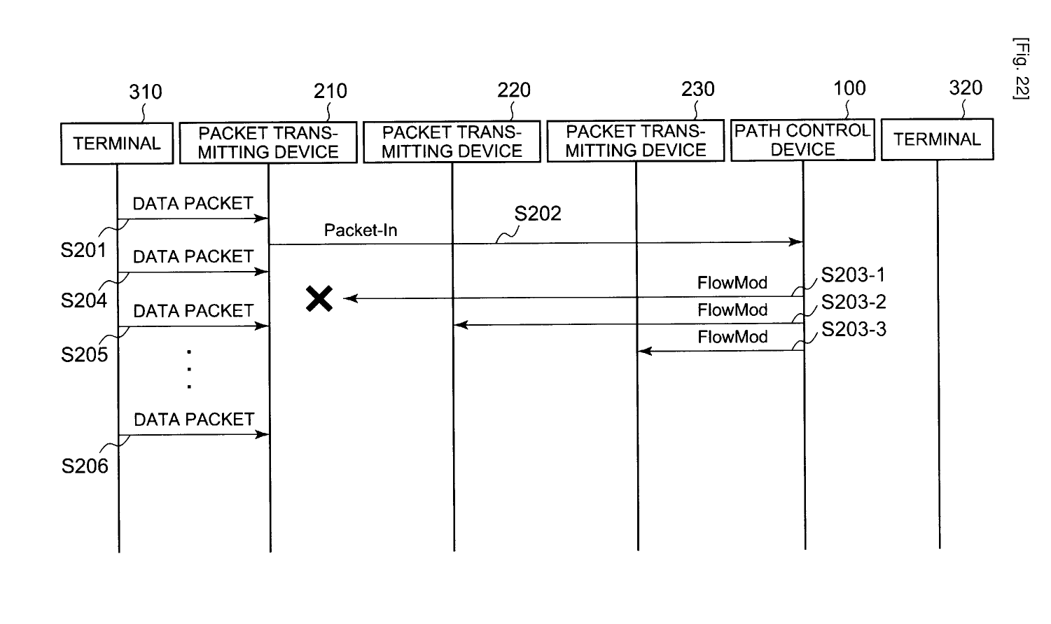

The following describes an operation when a data packet arrives at the built OpenFlow network, with reference to FIG. 21.

In the case where the terminal 310 sends a data packet to the terminal 320, the data packet arrives at the packet transmitting device 210 (step S901). When the packet transmitting device 210 receives the data packet, the packet management unit 213 searches the flow table for an entry including a comparison rule (matching key) that matches header information of the received packet. However, since the received packet is the first packet, there is no corresponding entry in the flow table. Accordingly, the packet management unit 213 buffers the received packet, and then sends an information message about detecting a new flow (Packet-In message) to the path control device (controller) 100 (step S902).

The Packet-In message includes information necessary for identifying the flow (e.g. a MAC address, an IP address, a port number (for both the source and the destination)) and information indicating a destination port of the packet.

It is assumed here that the packet transmitting device 210 buffers the received packet and sends the information necessary for identifying the flow to the path control device 100, but the packet transmitting device 210 may send the received packet itself to the path control device 100.

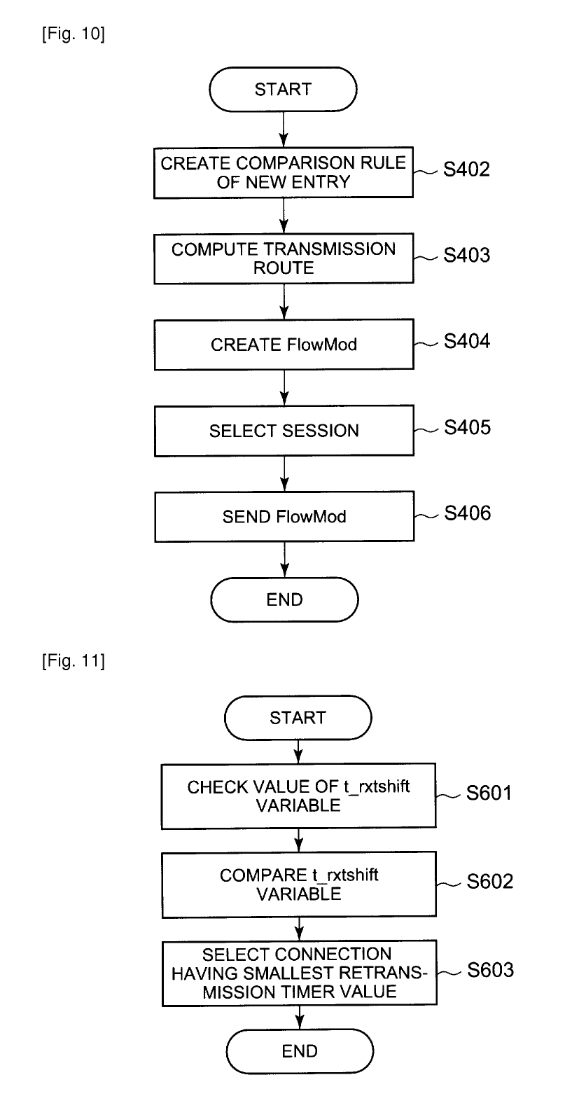

An operation when the path control device (controller) 100 receives the Packet-In message is described below. FIG. 10 is a flowchart showing an example of the operation when the path control device (controller) 100 receives the Packet-In message.

When the path control device (controller) 100 receives the Packet-In message, the path/action computing unit 103 creates a comparison rule (matching key) of a new entry based on the received information, and determines a timer value applied to the entry (step S402). Information created as the comparison rule is, for instance, the information from “InPort” to “TCP/UDP src port” illustrated in FIG. 20. The path/action computing unit 103 further checks a location of the terminal 320 as the destination based on the received information, and computes a packet transmission route from the terminal 310 to the terminal 320 (step S403). It is assumed here that, as a result of transmission route computation, the transmission route of transmitting the packet in the order of the packet transmitting device 210→the packet transmitting device 220→the packet transmitting device 230 is computed.

Next, the path/action computing unit 103 in the path control device (controller) 100 creates an entry (FlowMod message) in which an action defining transmission according to the computed transmission route and the timer value are set for a packet that matches the comparison rule (matching key) of the new entry, for each of the packet transmitting devices 210 to 230 (step S404). After the FlowMod message is created, the packet transmitting device communication unit 108 in the path control device (controller) 100 selects a session for sending the FlowMod message (step S405), and sends the process rule (FlowMod) using the selected session (step S406).

For example, in step S405, the packet transmitting device communication unit 108 selects the session used for sending the FlowMod message, based on a timer field of TCP. A method of selecting the session based on the timer field of TCP is described in detail below.

FIG. 11 is a flowchart showing an example of a process of selecting the session. In Example 1, the first session between the path control device (controller) 100 and the packet transmitting device 210 is denoted as a session A, and the second session between the path control device (controller) 100 and the packet transmitting device 210 is denoted as a session B.

In TCP, a retransmission timer expires if an acknowledgement packet is not received within a predetermined time from a device to which data is sent. Here, the expiration of the retransmission timer means that a predetermined wait time for an acknowledgement (ACK) has elapsed. Whether or not the retransmission timer expires can be determined by referencing to a t_rxtshift variable which is a variable indicating the number of times the retransmission timer expires for each session. When the value of the t_rxtshift variable is 0, the retransmission timer does not expire. When the value of the t_rxtshift variable is 1 or more, on the other hand, the retransmission timer expires. In detail, when the value of the t_rxtshift variable is K, K times retransmitting operations have been performed successively. The value of the t_rxtshift variable is hereafter also referred to as a t_rxtshift value or a retransmission timer value.

A larger value of this variable indicates a higher probability of arriving at its destination terminal. In other words, a session having a smaller value of this variable can be regarded as a session of higher quality.

In view of this, the packet transmitting device communication unit 108 in the path control device (controller) 100 checks the value of the t_rxtshift variable of each session (step S601). In Example 1, let a be the value of the t_rxtshift variable of the session A, and b (>=a) be the value of the t_rxtshift variable of the session B. “>=” means “not less than”. The packet transmitting device communication unit 108 in the path control device (controller) 100 compares a and b (step S602), and selects a session having a smallest retransmission timer value (step S603). In this example, the packet transmitting device communication unit 108 selects the session A having the smallest retransmission timer value. The packet transmitting device communication unit 108 in the path control device (controller) 100 then sends the FlowMod message using the session (i.e. the session A) determined in step S603.

Thus, a plurality of sessions are established between the path control device (controller) 100 and the packet transmitting devices 210 to 230, and the path control device (controller) 100 (more specifically, the packet transmitting device communication unit 108) selects a session of higher communication quality when sending a packet to the packet transmitting devices 210 to 230. This enables the path control device (controller) 100 to properly send a packet to the packet transmitting devices 210 to 230.

The above describes the process for sending the FlowMod, using communication between the path control device (controller) 100 and the packet transmitting device 210 as an example. The same applies to communication between the path control device (controller) 100 and the packet transmitting device 220 and communication between the path control device (controller) 100 and the packet transmitting device 230, and so their description is omitted.

When each of the packet transmitting devices 210 to 230 receives the FlowMod from the path control device (controller) 100, the control message sending/receiving unit 211 sets the received entry in the flow table. The packet management unit 213 transmits the buffered packet to the packet transmitting device 220, according to the set entry (step S904-1 in FIG. 21). The packet transmitting devices 220 and 230 on the transmission route through which the packet is to be transmitted have already set the entry, so that the packet is transmitted to the packet transmitting device 220 and then to the packet transmitting device 230, and eventually arrives at the terminal 320 (steps S904-2 and S904-3).

Subsequently, in the case of sending a packet from the terminal 310 to the terminal 320, the packet is transmitted in the order of the packet transmitting device 210→the packet transmitting device 220→the packet transmitting device 230 according to the transmission route (steps S905-1 to S905-4), and arrives at the terminal 320.

The following describes Variation 1 of Example 1. Example 1 describes the case where a plurality of sessions are established and a session to be used is selected according to a communication condition. Variation 1 differs from Example 1 in that a primary session (hereafter referred to as a primary session) and a secondary session (hereafter referred to as a secondary session) are determined between the path control device (controller) 100 and the packet transmitting device 210 beforehand. The primary session is used for communication between the devices in normal time, whereas the secondary session is used for communication between the devices when the primary session is anomalous.

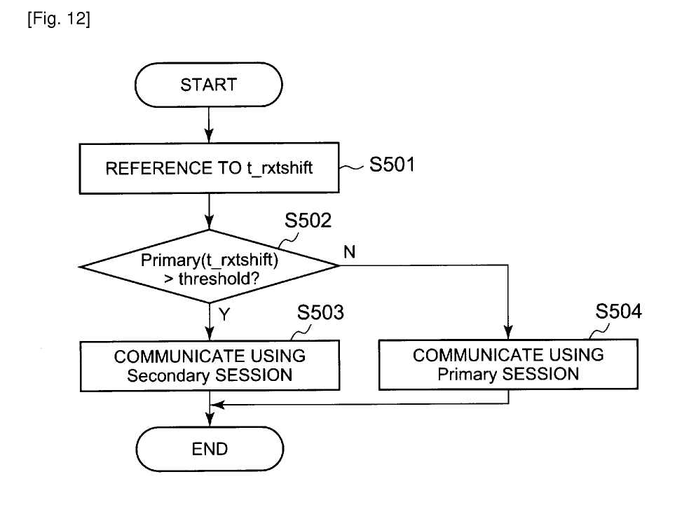

An operation of a communication control system in Variation 1 is described below. A process from when the path control device (controller) 100 receives the Packet-In message to when the path control device (controller) 100 creates the FlowMod message for each of the packet transmitting devices 210 to 230 is the same as steps S402 to S404 illustrated in FIG. 10. After this, the packet transmitting device communication unit 108 in the path control device (controller) 100 selects a session for sending the FlowMod message. An operation of selecting the session is described below, with reference to FIG. 12.

FIG. 12 is a flowchart showing an example of the operation of selecting the session. It is assumed here that the primary session is the session established first, and the secondary session is the session established second. First, to select the session, the packet transmitting device communication unit 108 references to the t_rxtshift value of the primary session (step S501), and compares the t_rxtshift value of the primary session with a value (hereafter referred to as a threshold) set beforehand as a reference value for determining an anomaly (step S502).

When the t_rxtshift value of the primary session is larger than the reference value (step S502: Y), the packet transmitting device communication unit 108 determines that the primary session is anomalous, and selects the secondary session instead of the primary session (step S503). When the t_rxtshift value of the primary session is not larger than the reference value (step S502: N), on the other hand, the packet transmitting device communication unit 108 determines that the primary session is in a normal communication condition, and selects the primary session (step S504). The packet transmitting device communication unit 108 in the path control device (controller) 100 then sends the FlowMod message to each of the packet transmitting devices 210 to 230 using the selected session.

According to this method, too, a session of higher communication quality can be selected, so that a transmission delay of a packet sent from the path control device (controller) 100 to the packet transmitting device can be suppressed.

The following describes Variation 2 of Example 1. Example 1 and Variation 1 of Example 1 describe the case where each session following the first session between the path control device (controller) 100 and the packet transmitting devices 210 to 230 is established at the time of building the network, too. In Variation 2, the first session is established at the time of building the network, as in Example 1 and Variation 1 of Example 1. Variation 2, however, differs from Example 1 and Variation 1 of Example 1 in that the second session is established at the time when an anomaly occurs in the first session.

An operation of a communication control system in Variation 2 is described below. A procedure when the packet transmitting device 210 joins the OpenFlow network managed by the path control device (controller) 100 is described first. Though the following describes the case where session establishment in the OpenFlow network is initiated by the packet transmitting devices 210 to 230, session establishment may instead be initiated by the path control device (controller) 100. First, the packet transmitting device 210 establishes a session for notifying the path control device 100 of information of the packet transmitting device 210, upon joining the network managed by the path control device (controller) 100. It is assumed here that the session is established in a secure channel (TCP or SSL).

The control message sending/receiving unit 211 in each of the packet transmitting devices 210 to 230 sends a session establishment request message (SYN message) to the path control device (controller) 100. The SYN message includes information such as a port number of a server to be connected. Suppose, for example, “6633” is designated in the SYN message as the port number of the server. When the path control device 100 receives this SYN message, the multiple session management unit 106 sends a SYN+ACK message to the packet transmitting device 210, according to a TCP session establishment procedure.

When the packet transmitting device 210 receives the SYN+ACK message, the control message sending/receiving unit 211 sends an ACK in response to the SYN+ACK message, to the path control device 100. As a result, one TCP session is established between the path control device 100 and the packet transmitting device 210. The OpenFlow network is built as a result of this procedure.

The following describes an operation when a data packet arrives at the built OpenFlow network, with reference to FIG. 21. In the case where the terminal 310 sends a data packet to the terminal 320, the data packet arrives at the packet transmitting device 210 (step S901). When the packet transmitting device 210 receives the data packet, the packet management unit 213 searches the flow table for an entry including a comparison rule (matching key) that matches header information of the received packet. However, since the received packet is the first packet, there is no corresponding entry in the flow table. Accordingly, the packet management unit 213 buffers the received packet, and then sends an information message about detecting a new flow (Packet-In message) to the path control device (controller) 100 (step S902).

The Packet-In message includes information necessary for identifying the flow (e.g. a MAC address, an IP address, a port number (for both the source and the destination)) and information indicating a destination port of the packet.

It is assumed here that the packet transmitting device 210 buffers the received packet and sends the information necessary for identifying the flow to the path control device 100, but the packet transmitting device 210 may send the received packet itself to the path control device 100.

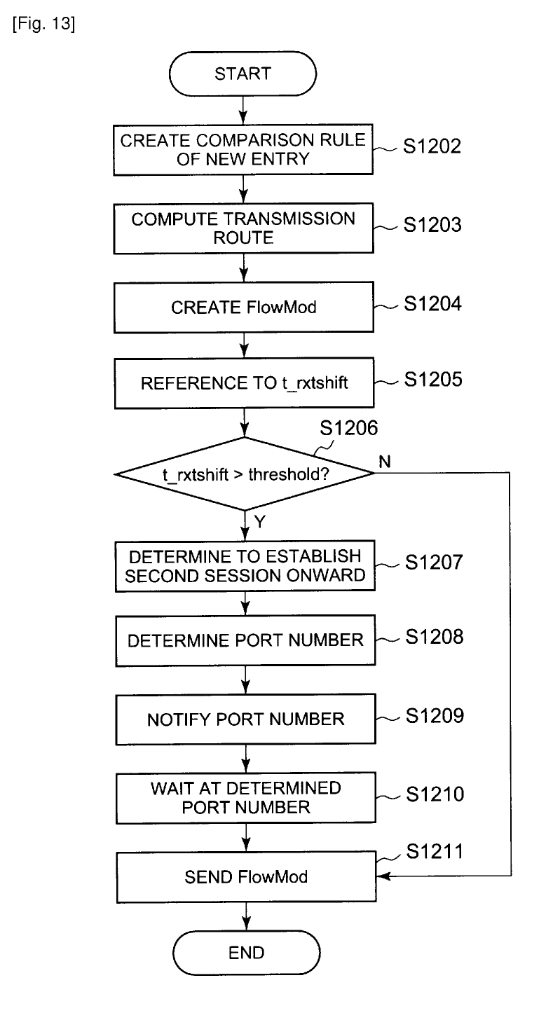

An operation when the path control device (controller) 100 receives the Packet-In message is described below. FIG. 13 is a flowchart showing an example of the operation when the path control device (controller) 100 receives the Packet-In message.

When the path control device (controller) 100 receives the Packet-In message, the path/action computing unit 103 creates a comparison rule (matching key) of a new entry based on the received information, and determines a timer value applied to the entry (step S1202). Information created as the comparison rule is, for instance, the information from “InPort” to “TCP/UDP src port” illustrated in FIG. 20. The path/action computing unit 103 further checks a location of the terminal 320 as the destination based on the received information, and computes a packet transmission route from the terminal 310 to the terminal 320 (step S1203). It is assumed here that, as a result of transmission route computation, the transmission route of transmitting the packet in the order of the packet transmitting device 210→the packet transmitting device 220→the packet transmitting device 230 is computed.

Next, the path/action computing unit 103 in the path control device (controller) 100 creates an entry (FlowMod message) in which an action defining transmission according to the computed transmission route and the timer value are set for a packet that matches the comparison rule (matching key) of the new entry, for each of the packet transmitting devices 210 to 230 (step S1204).

After this, the path control device (controller) 100 proceeds to a process of sending the created entry. The packet transmitting device communication unit 108 checks whether or not the session is in a state where a packet can be sent immediately. The variable (t_rxtshift) relating to the retransmission timer of TCP is used as an index for this check. When the retransmission timer value of TCP is larger than a predetermined value (threshold), it can be considered that a packet sent to the packet transmitting device does not arrive at the packet transmitting device.

The packet transmitting device communication unit 108 in the path control device (controller) 100 references to the t_rxtshift value (step S1205), and compares the t_rxtshift value with the value (threshold) set beforehand as a reference value for determining an anomaly (step S1206). Here, the threshold is used as a reference value when determining quality deterioration.

When the t_rxtshift value is larger than the threshold (step S1206: Y), the multiple session management unit 106 determines to establish the second session onward (step S1207).

The multiple session management unit 106 determines a port number necessary for establishing the second session (step S1208). The multiple session management unit 106 determines the port number other than the well-known port numbers. It is assumed here that the multiple session management unit 106 randomly determines the port number, and thus selects “1024” as the port number. Note that the method of determining the port number is not limited to such a random determination method. The multiple session management unit 106 may select, for example, a smallest port number from unused port numbers other than the well-known port numbers.

The packet transmitting device communication unit 108 notifies the packet transmitting device 210 of the port number determined by the multiple session management unit 106 (step S1209). The notification may be made by including the port number in an arbitrary message sent from the path control device 100 to the packet transmitting device 210, or in a dedicated message separately created for notifying the port number.

The path control device (controller) 100 then waits for a session establishment request from the packet transmitting device 210 at the port number “1024” (step S1210). The control message sending/receiving unit 211 in the packet transmitting device 210 sends a SYN message including the Feature port number “1024” to the path control device 100. A subsequent operation until a session is established is the same as the above-mentioned operation.

After the session is established, the packet transmitting device communication unit 108 in the path control device (controller) 100 sends the FlowMod to the packet transmitting devices 210 to 230 using the newly established session (step S1211).

When the t_rxtshift value is not larger than the threshold in step S1206 (step S1206: N), on the other hand, the packet transmitting device communication unit 108 sends the FlowMod to the packet transmitting devices 210 to 230 using the existing session (step S1211).

Step S1211 in FIG. 13 in which the FlowMod is sent corresponds to step S903 in FIG. 21. Subsequently, the data packet is sent to the terminal 320 in steps S904-1 to S904-3 and S905-1 to S905-4.

According to this method, too, a session of higher communication quality can be selected, so that a transmission delay of a packet sent from the path control device (controller) 100 to the packet transmitting device can be suppressed.

Though Exemplary Embodiment 1, Example 1, and Variations 1 and 2 of Example 1 all describe the case where one path control device (controller) establishes a plurality of sessions with one packet transmitting device, the number of path control devices (controllers) is not limited to one. Two or more path control devices (controllers) may establish a plurality of sessions with one packet transmitting device.

In Exemplary Embodiment 1, the multiple session management unit 106 establishes a plurality of secure channels between the path control device (controller) 100 and the packet transmitting devices 210 to 230. Typically, the number of secure channels established between the path control device (controller) 100 and the packet transmitting devices 210 to 230 is one. However, when there is only one secure channel, there is a possibility that a packet sent from the path control device (controller) 100 does not arrive at the packet transmitting devices 210 to 230 in the case where the secure channel has poor quality. In Exemplary Embodiment 1, on the other hand, a session of higher quality is selected from the plurality of sessions established by the multiple session management unit 106. This contributes to a high probability that a packet sent from the path control device (controller) 100 arrives at the packet transmitting device, as compared with, for example, the OpenFlow network described in each of PTL 1, NPL 1, and NPL 2.

### Example 2

The following describes Example 2 of the present invention. Example 2 corresponds to the communication control system in Exemplary Embodiment 2 of the present invention. A communication control system intended for the OpenFlow network is described in Example 2, as in Example 1.

The path control device (controller) 100 corresponds to a device that includes, in the OpenFlow controller, a function of selecting a sending mode according to a packet communication condition. Meanwhile, the packet transmitting device corresponds to the OpenFlow switch.

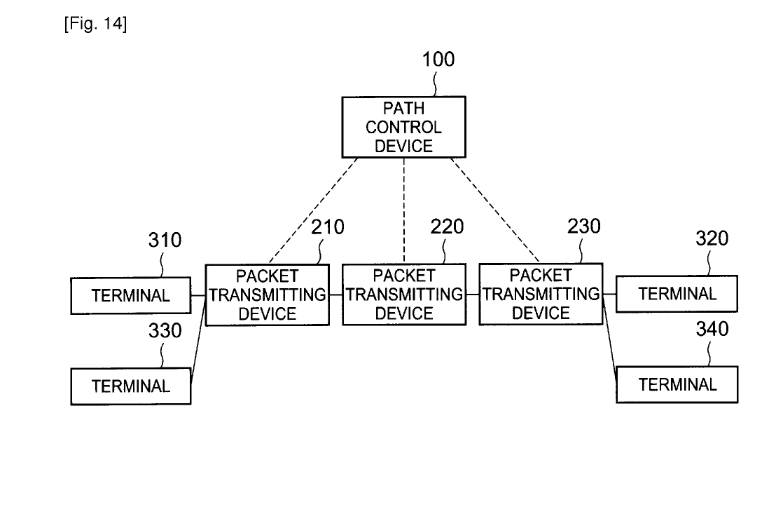

FIG. 14 is a block diagram showing an example of the communication control system in Example 2 of the present invention. The communication control system in Example 2 includes the path control device (controller) 100, the three packet transmitting devices 210 to 230, and four terminals 310 to 340. This communication control system constitutes the OpenFlow network. The three packet transmitting devices 210 to 230 exist between the terminals 310 to 340, and the path control device (controller) 100 controls the OpenFlow network.

It is assumed here that the terminal 310 sends a data packet to the terminal 320, and the terminal 330 sends a data packet to the terminal 340.

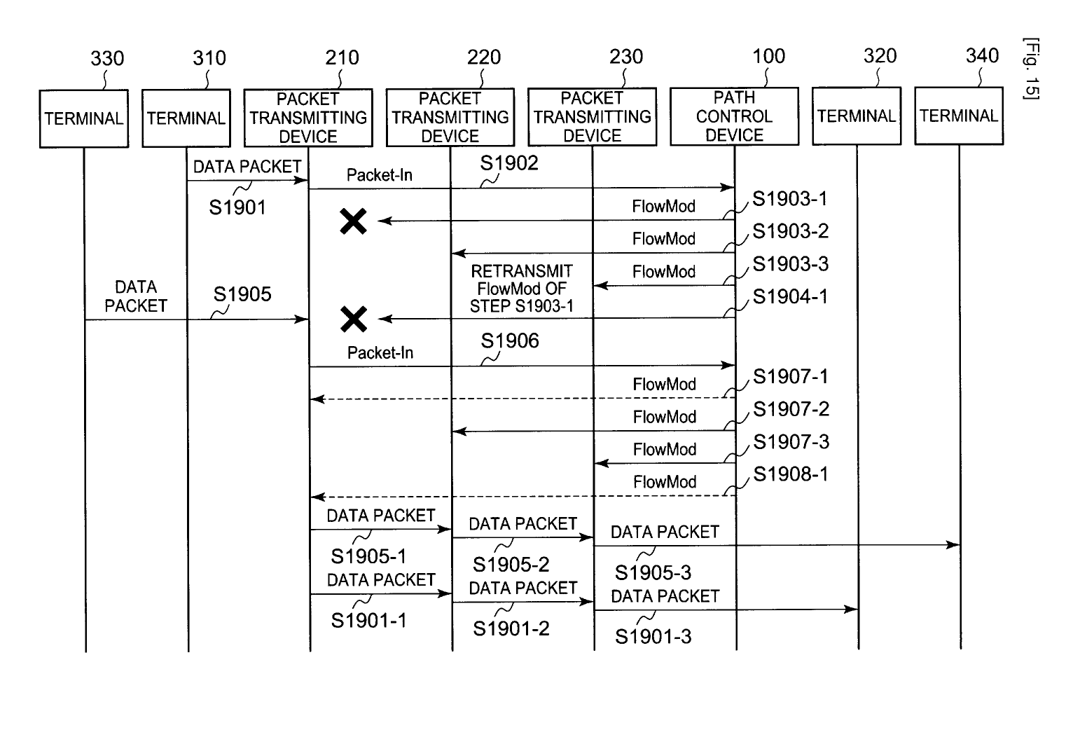

The following describes an operation when a data packet arrives at the built OpenFlow network. FIG. 15 is an explanatory diagram showing an example of a packet flow.

When the packet transmitting device 210 receives a data packet from the terminal 310 (step S1901), the packet management unit 213 searches the flow table for an entry including a comparison rule (matching key) that matches header information of the received packet. However, since the received packet is the first packet, there is no corresponding entry in the flow table. Accordingly, the packet management unit 213 buffers the received packet, and then sends an information message about detecting a new flow (Packet-In message) to the path control device (controller) 100 (step S1902).

The information message about detecting a new flow (Packet-In) includes information necessary for identifying the flow (e.g. a MAC address, an IP address, a port number (for both the source and the destination)) and information indicating a destination port of the packet.

It is assumed here that the packet transmitting device 210 buffers the received packet and sends the information necessary for identifying the flow to the path control device 100, but the packet transmitting device 210 may send the received packet itself to the path control device 100.

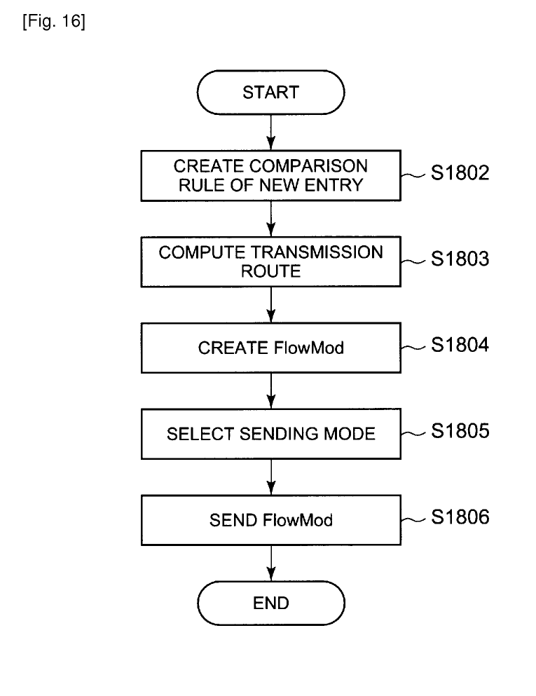

An operation when the path control device (controller) 100 receives the Packet-In message is described below. FIG. 16 is a flowchart showing an example of the operation when the path control device (controller) 100 receives the Packet-In message.

When the path control device (controller) 100 receives the information message about detecting a new flow (Packet-In), the path/action computing unit 103 creates a comparison rule (matching key) of a new entry based on the received information, and determines a timer value applied to the entry (step S1802). Information created as the comparison rule is, for instance, the information from “InPort” to “TCP/UDP src port” illustrated in FIG. 20. The path/action computing unit 103 further checks a location of the terminal 320 as the destination based on the received information, and computes a packet transmission route from the terminal 310 to the terminal 320 (step S1803). It is assumed here that, as a result of transmission route computation, the transmission route of transmitting the packet in the order of the packet transmitting device 210→the packet transmitting device 220→the packet transmitting device 230 is computed.

Next, the path/action computing unit 103 in the path control device (controller) 100 creates an entry (FlowMod) in which an action defining transmission according to the computed transmission route and the timer value are set for a packet that matches the comparison rule (matching key) of the new entry, for each of the packet transmitting devices 210 to 230 (step S1804).

Following this, the packet transmitting device communication unit 108 in the path control device (controller) 100 selects a packet sending mode (step S1805), and sends the FlowMod in the selected sending mode (step S1806).

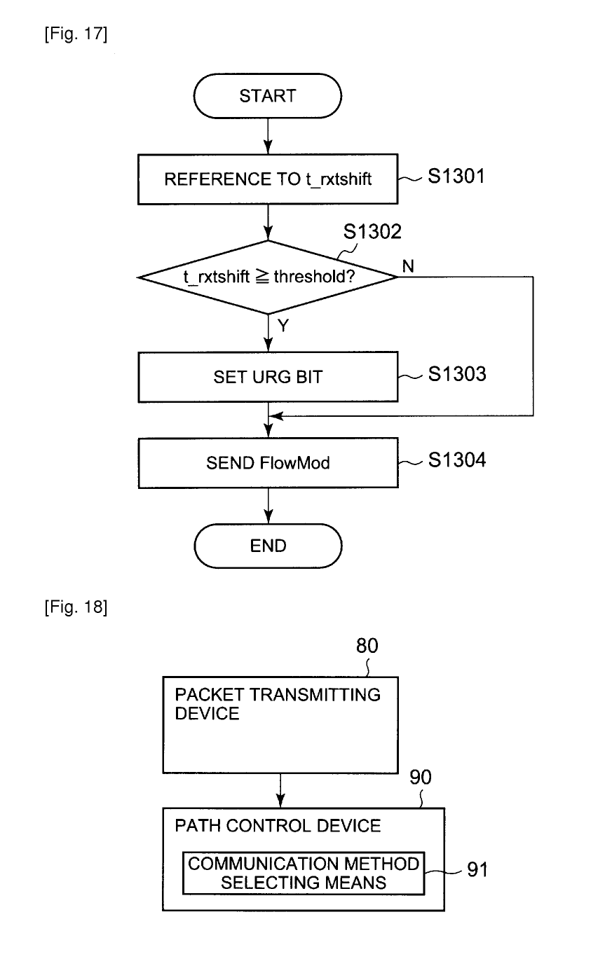

The following describes a method of selecting the packet sending mode by the packet transmitting device communication unit 108 in step S1805. FIG. 17 is a flowchart showing an example of a process of selecting the packet sending mode. In Example 2, the variable (t_rxtshift) indicating the number of times the retransmission timer of TCP expires is used when selecting the sending mode.

The packet transmitting device communication unit 108 in the path control device (controller) 100 first references to the t_rxtshift value which is the variable indicating the number of times the retransmission timer of TCP expires (step S1301). The packet transmitting device communication unit 108 compares the t_rxtshift value with the value (threshold) set beforehand as a reference value for determining an anomaly, to determine whether or not the t_rxtshift value is not smaller than the threshold (step S1302). Here, threshold>=1 indicates that TCP is in the retransmission phase, and so threshold=1 is set beforehand.

It is assumed that no packet loss occurs before the path control device (controller) 100 receives the Packet-In from the packet transmitting device 210. That is, the t_rxtshift value is initially 0. Hence, t_rxtshift>=threshold is false (i.e. it is determined that the t_rxtshift value is smaller than the threshold) (step S1302: N), and so the packet transmitting device communication unit 108 in the path control device (controller) 100 sends the FlowMod to the packet transmitting device 210 in a normal manner (step S1304). A process performed when it is determined that the t_rxtshift value is not smaller than the threshold (step S1302: Y) will be described later.

Step S1304 in FIG. 17 in which the FlowMod is sent corresponds to step S1903-1 in FIG. 15. It is also assumed that no packet loss occurs in communication in a session between the path control device (controller) 100 and the packet transmitting device 220 and a session between the path control device (controller) 100 and the packet transmitting device 230. This being so, the same process as above is performed in the path control device (controller) 100, and the packet transmitting device communication unit 108 in the path control device (controller) 100 sends the FlowMod to the packet transmitting devices 220 and 230 (steps S1903-2 and S1903-3 in FIG. 15).

Suppose the FlowMod message to the packet transmitting device 220 (the FlowMod message sent in step S1903-2) and the FlowMod message to the packet transmitting device 230 (the FlowMod message sent in step S1903-3) arrive at the packet transmitting devices 220 and 230 respectively, but the FlowMod message to the packet transmitting device 210 (the FlowMod message sent in step S1903-1) does not arrive at the packet transmitting device 210.

A timer activation unit (not shown) in the path control device (controller) 100 starts a timer upon sending each FlowMod (steps S1903-1, S1903-2, and S1903-3). An operation of the timer activation unit (not shown) that starts the timer is an operation defined in TCP. According to TCP, the timer activation unit (not shown) receives an acknowledgement of receipt of the sent packet before the timer expires, thereby confirming that the sent packet arrives at the packet transmitting device.

As illustrated in FIG. 15, a packet loss occurs in the communication of the FlowMod sent in step S1903-1, so that the timer activation unit (not shown) in the path control device (controller) 100 is unable to receive the acknowledgement of receipt before the timer expires. In such a case, the timer activation unit (not shown) increments the t_rxtshift value by 1 according to TCP (t_rxtshift=1). The packet transmitting device communication unit 108 then retransmits the FlowMod sent in step S1903-1 (step S1904-1). If this FlowMod is lost, too, the timer activation unit (not shown) further increments the t_rxtshift value by 1 according to TCP (t_rxtshift=2).

In such a situation, when a data packet sent from the terminal 330 to the terminal 340 arrives at the packet transmitting device 210 (step S1905), the packet transmitting device 210 searches the flow table for an entry including a comparison rule (matching key) that matches header information of the received packet. However, since the received packet is the first packet, there is no corresponding entry in the flow table. Accordingly, the packet management unit 213 buffers the received packet, and then sends an information message about detecting a new flow (Packet-In) to the path control device (controller) 100 (step S1906).

The information message about detecting a new flow (Packet-In) includes information necessary for identifying the flow (e.g. a MAC address, an IP address, a port number (for both the source and the destination)) and information indicating a destination port of the packet.

It is assumed here that the packet transmitting device 210 buffers the received packet and sends the information necessary for identifying the flow to the path control device 100, but the packet transmitting device 210 may send the received packet itself to the path control device 100.

An operation when the path control device (controller) 100 receives the Packet-In message is described below, with reference to FIG. 16.

When the path control device (controller) 100 receives the information message about detecting a new flow (Packet-In), the path/action computing unit 103 creates a comparison rule (matching key) of a new entry based on the received information, and determines a timer value applied to the entry (step S1802). Information created as the comparison rule is, for instance, the information from “InPort” to “TCP/UDP src port” illustrated in FIG. 20. The path/action computing unit 103 further checks a location of the terminal 340 as the destination based on the received information, and computes a packet transmission route from the terminal 330 to the terminal 340 (step S1803). It is assumed here that, as a result of transmission route computation, the transmission route of transmitting the packet in the order of the packet transmitting device 210→the packet transmitting device 220→the packet transmitting device 230 is computed.

Next, the path/action computing unit 103 in the path control device (controller) 100 creates an entry (FlowMod) in which an action defining transmission according to the computed transmission route and the timer value are set for a packet that matches the comparison rule (matching key) of the new entry, for each of the packet transmitting devices 210 to 230 (step S1804).

Following this, the packet transmitting device communication unit 108 in the path control device (controller) 100 selects a packet sending mode (step S1805), and sends the FlowMod in the selected sending mode (step S1806).

The following describes a method of selecting the packet sending mode by the packet transmitting device communication unit 108 in step S1805, with reference to FIG. 17.

The packet transmitting device communication unit 108 in the path control device (controller) 100 first references to the t_rxtshift value which is the variable indicating the number of times the retransmission timer of TCP expires (step S1301). The packet transmitting device communication unit 108 determines whether or not the t_rxtshift value is not smaller than the threshold (step S1302). As a result of step S1904-1 and the second retransmitting operation, t_rxtshift=2, indicating that TCP is in the retransmission phase.

Hence, t_rxtshift>=threshold is true (i.e. it is determined that the t_rxtshift value is not smaller than the threshold) (step S1302: Y), and so the packet transmitting device communication unit 108 sets a URG bit in a TCP header according to TCP (step S1303). The URG bit is information indicating that urgent data is included in a TCP packet. TCP defines that the retransmission timer is reset (i.e. t_rxtshift=0) when the packet in which the URG bit is set is registered. This enables the packet transmitting device communication unit 108 to immediately send the packet (FlowMod) (step S1304).

Step S1304 in which the FlowMod is sent corresponds to step S1907-1 in FIG. 15. The path control device 100 sends the FlowMod to the packet transmitting device 210, so that the packet transmitting device 210 can receive the FlowMod in response to the Packet-In sent in step S1906 (step S1907-1). The same process as above is performed in the path control device (controller) 100, and the packet transmitting device communication unit 108 in the path control device (controller) 100 sends the FlowMod to the packet transmitting devices 220 and 230 (steps S1907-2 and S1907-3).

The packet transmitting device communication unit 108 further performs the same operation for the FlowMod in step S1908-1 corresponding to the data packet sent in step S1901, thereby sending the FlowMod to the packet transmitting device 210 (step S1908-1).

When each of the packet transmitting devices 210 to 230 receives the process rule (FlowMod) from the path control device (controller) 100, the control message sending/receiving unit 211 sets the received entry in the flow table. The packet management unit 213 transmits the buffered packet to the packet transmitting device 220, according to the set entry (steps S1905-1 and S1901-1 in FIG. 15). The packet transmitting devices 220 and 230 on the transmission route through which the packet is to be transmitted have already set the entry, so that the packet is transmitted to the packet transmitting device 220 and then to the packet transmitting device 230, and eventually arrives at the terminal 320 and the terminal 340 (steps S1905-2, S1901-2, S1905-3, and S1901-3).

Though Exemplary Embodiments 1 and 2 describe the case where the packet transmitting device communication unit 108 determines whether or not to send the FlowMod in the urgent mode, the message subject to the determination of whether or not to send in the urgent mode is not limited to the FlowMod. For example, the packet transmitting device communication unit 108 may determine whether or not to send a packet in the urgent mode, based on importance of the packet.

The following describes a minimum structure of the present invention. FIG. 18 is a block diagram showing an example of a minimum structure of a communication control system according to the present invention. The communication control system according to the present invention comprises: a packet transmitting device 80 (e.g. the packet transmitting devices 210 to 230) for transmitting a received packet according to a packet process rule which is a rule defining a process for the packet; and a control device 90 (e.g. the path control device 100) for controlling a transmission route of the packet, by instructing the packet transmitting device to apply the packet process rule.

The control device 90 includes communication method selecting means 91 (e.g. the packet transmitting device communication unit 108) for selecting a communication method with the packet transmitting device 80, according to a communication condition with the packet transmitting device 80.

According to this structure, in a network in which a control device sends a process rule to a packet management device, a transmission delay of a packet sent from the control device to the packet management device can be suppressed.

The control device 90 may include multiple session establishing means (e.g. the multiple session management unit 106) for establishing a plurality of sessions with the packet transmitting device 80, wherein the communication method selecting means 91 selects a session used for communication with the packet transmitting device 80 from the plurality of sessions, according to the communication condition with the packet transmitting device 80 with which the plurality of sessions are established.

The communication method selecting means 91 may select the communication method of sending a packet in an urgent mode which is a mode of sending the packet with higher priority than in normal time, according to the communication condition with the packet transmitting device 80.

The multiple session establishing means may determine a primary session (primary session) and a secondary session (secondary session) beforehand among the plurality of sessions, the primary session being a session used for normal communication, and the secondary session being a session used when the primary session is anomalous, wherein the communication method selecting means 91 selects the primary session in normal time, and selects the secondary session when the primary session is anomalous.

The multiple session establishing means may add a connection established with the packet transmitting device, according to the communication condition with the packet transmitting device, wherein, in the case where a packet sent to the packet transmitting device 80 does not arrive at the packet transmitting device 80, the communication method selecting means 91 selects the connection added by the multiple session establishing means according to the communication condition, as the session used for the communication with the packet transmitting device.

The communication method selecting means 91 may determine quality of the communication condition with the packet transmitting device, based on a retransmission timer defined in TCP. Moreover, the communication method selecting means 91 may select the communication method with the packet transmitting device, based on importance of a packet to be sent.

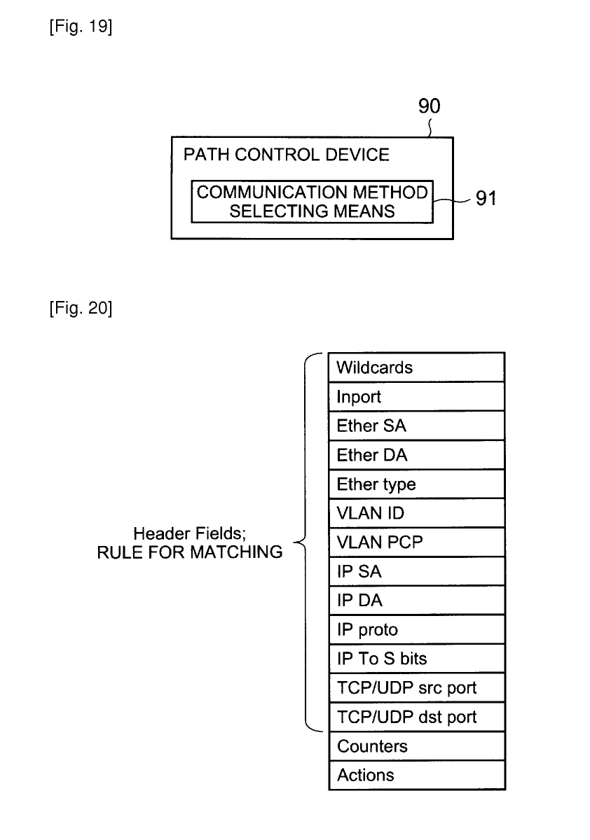

FIG. 19 is a block diagram showing an example of a minimum structure of a control device according to the present invention. The control device illustrated in FIG. 19 is the same as the control device 90 illustrated in FIG. 18. According to this structure, too, a transmission delay of a packet sent from the control device to the packet management device can be suppressed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2010-278544, filed on Dec. 14, 2010, the disclosure of which is incorporated herein in its entirety by reference.

### INDUSTRIAL APPLICABILITY

The present invention is preferably applied to a communication control system for controlling communication while suppressing a transmission delay of a packet sent to another device.

### REFERENCE SIGNS LIST

100 path control device
101 flow entry storage unit
102 topology management unit
103 path/action computing unit
104 flow entry management unit
105 control message management unit
106 multiple session management unit
107 terminal location storage unit
108 packet transmitting device communication unit
210 to 230 packet transmitting device
211 control message sending/receiving unit
212 flow table storage unit
213 packet management unit
310 to 340 terminal

1. A communication control system comprising:
a packet transmitting device for transmitting a received packet according to a packet process rule which is a rule defining a process for the packet; and
a control device for controlling a transmission route of the packet, by instructing the packet transmitting device to apply the packet process rule,
wherein the control device includes
a communication method selecting unit for selecting a communication method with the packet transmitting device, according to a communication condition with the packet transmitting device.

2. The communication control system according to claim 1, wherein the control device includes
a multiple session establishing unit for establishing a plurality of sessions with the packet transmitting device, and
wherein the communication method selecting unit selects a session used for communication with the packet transmitting device from the plurality of sessions, according to the communication condition with the packet transmitting device with which the plurality of sessions are established.

3. The communication control system according to claim 1, wherein the communication method selecting unit selects the communication method of sending a packet in an urgent mode which is a mode of sending the packet with higher priority than in normal time, according to the communication condition with the packet transmitting device.

4. The communication control system according to claim 2, wherein the multiple session establishing unit determines a primary session and a secondary session beforehand among the plurality of sessions, the primary session being a session used for normal communication, and the secondary session being a session used when the primary session is anomalous, and
wherein the communication method selecting unit selects the primary session in normal time, and selects the secondary session when the primary session is anomalous.

5. The communication control system according to claim 2, wherein the multiple session establishing unit adds a connection established with the packet transmitting device, according to the communication condition with the packet transmitting device, and
wherein, in the case where a packet sent to the packet transmitting device does not arrive at the packet transmitting device, the communication method selecting unit selects the connection added by the multiple session establishing unit according to the communication condition, as the session used for the communication with the packet transmitting device.

6. The communication control system according to claim 1, wherein the communication method selecting unit determines quality of the communication condition with the packet transmitting device, based on a retransmission timer defined in TCP.

7. The communication control system according to claim 1, wherein the communication method selecting unit selects the communication method with the packet transmitting device, based on importance of a packet to be sent.

8. A control device for controlling a transmission route of a packet by instructing a packet transmitting device to apply a packet process rule which is a rule defining a process for the packet, the packet transmitting device transmitting the received packet according to the packet process rule, the control device comprising
a communication method selecting unit for selecting a communication method with the packet transmitting device, according to a communication condition with the packet transmitting device.

9. A communication control method wherein a control device for controlling a transmission route of a packet by instructing a packet transmitting device to apply a packet process rule which is a rule defining a process for the packet selects a communication method with the packet transmitting device according to a communication condition with the packet transmitting device, the packet transmitting device transmitting the received packet according to the packet process rule.

10. A computer readable information recording medium storing a communication control program for use in a computer for controlling a transmission route of a packet by instructing a packet transmitting device to apply a packet process rule which is a rule defining a process for the packet, the packet transmitting device transmitting the received packet according to the packet process rule, the communication control program, when executed by a processor, performs a method for:
selecting a communication method with the packet transmitting device, according to a communication condition with the packet transmitting device.

11. The communication control system according to claim 2, wherein the communication method selecting unit determines quality of the communication condition with the packet transmitting device, based on a retransmission timer defined in TCP.

12. The communication control system according to claim 3, wherein the communication method selecting unit determines quality of the communication condition with the packet transmitting device, based on a retransmission timer defined in TCP.

13. The communication control system according to claim 4, wherein the communication method selecting unit determines quality of the communication condition with the packet transmitting device, based on a retransmission timer defined in TCP.

14. The communication control system according to claim 5, wherein the communication method selecting unit determines quality of the communication condition with the packet transmitting device, based on a retransmission timer defined in TCP.

15. The communication control system according to claim 2, wherein the communication method selecting unit selects the communication method with the packet transmitting device, based on importance of a packet to be sent.

16. The communication control system according to claim 3, wherein the communication method selecting unit selects the communication method with the packet transmitting device, based on importance of a packet to be sent.

17. The communication control system according to claim 4, wherein the communication method selecting unit selects the communication method with the packet transmitting device, based on importance of a packet to be sent.

18. The communication control system according to claim 5, wherein the communication method selecting unit selects the communication method with the packet transmitting device, based on importance of a packet to be sent.

19. The communication control system according to claim 6, wherein the communication method selecting unit selects the communication method with the packet transmitting device, based on importance of a packet to be sent.
